(19) United States
(12) Patent Application Publication
(10) Pub. No.: US 2022/0322767 A1
(43) Pub. Date: Oct. 13, 2022

(54) FACE MASK AND FRAME

(71) Applicant: INNOVATIVE PRODUCT SOLUTIONS, LLC, Ogden, UT (US)

(72) Inventors: Jeffrey D. Hancock, Uintah, UT (US); Christopher N. Schenck, Uintah, UT (US)

(21) Appl. No.: 17/225,919

(22) Filed: Apr. 8, 2021

(51) Int. Cl. A41D 13/11

(52) U.S. Cl. CPC A41D 13/1184; A41D 13/1169

(57) ABSTRACT

An eyeglasses-like frame may include a central section that horizontally traverses a wearer's face. The central section may include a first cheek portion sized and configured to be disposed at least proximate a cheek of the wearer, and a second cheek portion sized and configured to be disposed at least proximate a cheek of the wearer. A bridge portion may be generally horizontally disposed between the first cheek portion and the second cheek portion. The first cheek portion, the second cheek portion, and the bridge portion may be disposed below a lower portion of the wearer's eyes. The eyeglasses-like frame may include a left temple section connected to the central section via a first hinge and a right temple section connected to the central section by a second hinge. A mask may be connected to the frame and the mask may be adjustable to tighten around the wearer's face.

The present invention is generally directed to a face mask and, in particular, to a face mask that may be attached to frame.

### BACKGROUND

Eyeglass frames have been used to hold lenses that provide various benefits to a wearer, including improved vision, dimming overly bright settings, and protection from debris and foreign objects. Eyeglass frames are generally designed to hold the lens in front of the wearer's eyes to maximize the effectiveness of the eyeglasses. Eyeglass frames are often developed to conform to a wearer's head and to maximize comfortability, especially in instances where a wearer may use the eyeglass frames for long periods of time, such as vision correction.

Face masks are regularly worn in various settings, such as by painters, construction workers, doctors, nurses, dentists, and the like. Additionally, instances may arise when others may wear face masks, such as during a pandemic, instances of airborne illness, and when an individual is not healthy or feeling well. Face masks are often worn with elastic and/or non-elastic loops around a wearer's ears, neck, and/or head. In many instances, face masks are made in only one size, which may cause discomfort when worn for long periods of time. Wearers of ill-fitting face masks often struggle to keep the face mask in a desired position. Conventional face masks may also be uncomfortable to wear when talking. In addition, breathing and other activities may cause the face mask to inadvertently move. Further, some face masks provide very little space between the face mask and the nostrils or mouth of the user, which may impede the wearer's ability to easily breathe and may make the mask uncomfortable to wear.

This disclosure and the claimed subject matter are not limited to embodiments that solve any disadvantages or that operate only in environments such as those described above. Rather, this background is only provided to illustrate one example area where some exemplary embodiments may be used or practiced.

### SUMMARY

People may wear eyeglasses for vision correction and various safety measures. Some eyeglasses may be adapted for utility and comfort such that a wearer may be able to use the eyeglasses for long periods of time. Some eyeglasses may limit peripheral vision and may obscure other portions of a wearer's view.

Face masks may be used in various settings and face masks may be part of personal protective equipment. In some circumstances, face masks may be worn to limit particulates that may be dispersed and/or spread, such as when breathing, coughing, sneezing, etc. Face masks may restrict the number of particulates emitted by the wearer of the face mask, and face masks may limit intake of external particulates for the wearer.

Wearing both eyeglasses and a face mask may provide the benefits of each, such as vision correction, eye protection, and restricting the flow of particulates. Wearing both eyeglasses and a face mask, however, may include a number of disadvantages such as limited peripheral vision, obscured vision, discomfort from extended use of a face mask, and need for require periodic adjustments. In addition, it may be common for eyeglasses to fog or otherwise become obscured when wearing both eyeglasses and a face mask.

One aspect is a frame that may include a central section and the central section may horizontally traverse at least a portion of a wearer's face. In some embodiments, the central section may be located below the wearer's eyes. The central section may extend from one side to the other side of the wearer's face. In some embodiments, the central section may include a bridge portion and the bridge portion may be disposed in the middle of the central section. The bridge portion may be sized and configured to span at least a portion of the user's nose. In some embodiments, the central section may include a first nose pad and the first nose pad may be disposed on a first side of the bridge portion. The central section may also include a second nose pad and the second nose pad may be disposed on a second side of the bridge portion. In some embodiments, the bridge portion may be at least substantially disposed between the first and second nose pads. The bridge portion may be generally horizontally disposed, and the bridge portion may be disposed generally parallel to the central section. For example, the bridge portion may be generally disposed in a first plane and the central section may be generally disposed in a second plane, and the first and second planes may be disposed in a generally parallel configuration.

Another aspect is a frame that may include a left temple section and the left temple section may be connected to the central section via a first hinge. In some embodiments, the left temple section may extend from the first hinge to a position above the wearer's left ear. The frame may include a right temple section and the right temple section may be connected to the central section via a second hinge. In some embodiments, the right temple section may extend from the second hinge to a position above the wearer's right ear.

Still another aspect is a face mask that may be connected to the frame. For example, the face mask may include a fabric portion that is attached to the frame. The face mask may be selectively and/or removably attached to the frame by one or more clips, fasteners, hook and loop fasteners, and the like. The face mask may also be permanently attached to the frame.

Another aspect is an eyeglasses-like frame that may include a central section that is sized and configured to horizontally traverse at least a portion of a wearer's face. The central section may include a first cheek portion sized and configured to be disposed at least proximate a cheek of the wearer; a second cheek portion sized and configured to be disposed at least proximate a cheek of the wearer, the first cheek portion and the second cheek portion may be generally horizontally aligned; a first nose pad may be disposed proximate the first cheek portion; a second nose pad may be disposed proximate the second cheek portion, the first nose pad and the second nose pad may be spaced apart by a distance; and a bridge portion may be disposed between the first cheek portion and the second cheek portion. The bridge portion may be generally horizontally aligned. The bridge portion may be horizontally disposed above the first cheek portion and the second cheek portion. The bridge portion may be disposed below a lower portion of the wearer's eyes. A first temple section may be connected to a first side of the central section, and a second temple section may be connected to a second side of the central section.

The bridge portion may be generally aligned with a lower portion of the first nose pad and a lower portion of the second nose pad. The connection of the first temple section and the central section may be disposed at least proximate a first lowermost portion of the frame; and the connection of the second temple section and the central section may be disposed at least proximate a second lowermost portion of the frame. The bridge portion may be disposed between a generally horizontal plane aligned with the first cheek portion and the second cheek portion, and a generally horizontal plane aligned with a midpoint of the first nose pad and the second nose pad. The first temple section may extend from a first lowermost portion of the central section to a position above the wearer's left ear, and the second temple section may extend from a second lowermost portion of the central section to a position above the wearer's right ear.

The frame may include a first groove that may extend from a first end of the central section to the first nose pad, the first groove may be sized and configured to receive a first lens; and a second groove that may extend from a second end of the central section to the second nose pad, the second groove may be sized and configured to receive a second lens. The central section of the frame may include one or more magnetic elements sized and configured to facilitate attachment of a mask to the frame. The frame may include one or more attachment portions disposed in the first temple section and one or more attachment portions disposed in the second temple section, the one or more attachment portions may be sized and configured to facilitate attachment of a mask to the frame. The frame may include hook and loop fasteners attached to the central section of the frame, and the hook and loop fasteners may be sized and configured to facilitate attachment of a mask to the frame. The frame may include a first padded insert attached to the first nose pad; a second padded insert attached to the second nose pad; a first sleeve attached to the first temple section; and a second sleeve attached to the second temple section. The first padded insert, the second padded insert, the first sleeve, and the second sleeve may be comprised of silicone.

Still another aspect is a mask may be attached to the frame. In an exemplary embodiment, the mask may be connected to the first cheek portion, the second cheek portion, and the bridge portion. In another exemplary embodiment, a first portion of the mask may be inserted through a first opening in the frame to attach the mask to the frame, and a second portion of the mask may be inserted through a second opening in the frame to attach the mask to the frame. In another exemplary embodiment, at least a portion of the first cheek portion may include a reusable adhesive; at least a portion of the second cheek portion may include a reusable adhesive; at least a portion of the bridge portion may include a reusable adhesive; and the reusable adhesive may be sized and configured to facilitate attachment of a mask to the frame. In another exemplary embodiment, a first lateral outer portion of the mask may include a hook and loop fastener sized and configured to facilitate attachment of the mask to the frame, and a second lateral outer portion of the mask may include a hook and loop fastener sized and configured to facilitate attachment of the mask to the frame. In another exemplary embodiment, one or more openings may be disposed in the first temple section; one or more opening may be disposed in the second temple section; and an adjustment mechanism may be sized and configured to adjust the mask relative to the wearer's face, the adjustment mechanism may include a line extending through the one or more openings in the first temple section, the one or more openings in the second temple section, and one or more portions of the mask. In another exemplary embodiment, a first sleeve may be attached to the first temple section; a second sleeve may be attached to the second temple section; and an adjustment mechanism may be sized and configured to adjust the mask relative to the wearer's face, the adjustment mechanism may include a line extending through a portion of the first sleeve, a portion of the second sleeve, and one or more portions of the mask.

A further aspect is an eyeglasses-like frame may include a central section sized and configured to horizontally traverse at least a portion of a wearer's face. The central section may include a first cheek portion sized and configured to be disposed at least proximate a cheek of the wearer; a second cheek portion sized and configured to be disposed at least proximate a cheek of the wearer; a bridge portion disposed between the first cheek portion and the second cheek portion; a first nose pad disposed between the first cheek portion and the bridge portion; and a second nose pad disposed between the second cheek portion and the bridge portion. A first temple section may be connected to a first side of the central section, and a second temple section may be connected to a second side of the central section. The bridge portion may extend upwardly and may have a generally inverted U-shaped configuration; and a first surface of the bridge portion may be generally vertically aligned with a first surface of the first cheek portion and a first surface of the second cheek portion. A mask may be attached to the frame, and the mask may be connected to the first cheek portion and the second cheek portion; one or more openings disposed in the first temple section; one or more opening disposed in the second temple section; and an adjustment mechanism may be sized and configured to adjust the mask relative to the wearer's face, the adjustment mechanism may comprising a line extending through the one or more openings in the first temple section, the one or more openings in the second temple section, and one or more portions of the mask. A mask may be attached to the frame by a first opening in the central section of the frame; a first connector connecting the mask to the first opening in the central section of the frame; a second opening in the central section of the frame; a second connector connecting the mask to the second opening in the central section of the frame; a first opening in the mask; a third connector connecting the first opening in the mask to the central section of the frame; a second opening in the mask; and a fourth connector connecting the second opening in the mask to the central section of the frame.

These and other aspects, features and advantages may become more fully apparent from the following brief description of the drawings, the drawings, the detailed description, and appended claims.

The objects and advantages of the example embodiments may be realized and/or achieved by one or more of the elements, features, and/or combinations of elements and features. Both the foregoing general description and the following detailed description are given as examples, and these descriptions are explanatory and are not restrictive of the invention.

### BRIEF DESCRIPTION OF THE DRAWINGS

The appended drawings contain figures of example embodiments to further illustrate and clarify the above and other aspects, advantages, and features of the present invention. It will be appreciated that these drawings depict only example embodiments of the invention and are not intended to limit its scope. Additionally, it will be appreciated that while the drawings may illustrate preferred sizes, scales, relationships and configurations of the invention, the drawings are not intended to limit the scope of the claimed invention. Example embodiments will be described and explained with additional specificity and detail through the use of the accompanying drawings in which:

FIG. 1 is a perspective view of an exemplary frame;

FIG. 2 is another perspective view of the frame shown in FIG. 1;

FIG. 3 is a right side view of the frame shown in FIG. 1;

FIG. 4 is a left side view of the frame shown in FIG. 1;

FIG. 5 is a front view of the frame shown in FIG. 1;

FIG. 6 is a rear view of the frame shown in FIG. 1;

FIG. 7 is a top view of the frame shown in FIG. 1;

FIG. 8 is a bottom view of the frame shown in FIG. 1;

FIG. 9 is a perspective view of another exemplary frame;

FIG. 10 is another perspective view of the frame shown in FIG. 9;

FIG. 11 is a right side view of the frame shown in FIG. 9;

FIG. 12 is a left side view of the frame shown in FIG. 9;

FIG. 13 is a front view of the frame shown in FIG. 9;

FIG. 14 is a rear view of the frame shown in FIG. 9;

FIG. 15 is a top view of the frame shown in FIG. 9;

FIG. 16 is a bottom view of the frame shown in FIG. 9;

FIG. 17 is a perspective view of still another exemplary frame;

FIG. 18 is another perspective view of the frame shown in FIG. 17;

FIG. 19 is a right side view of the frame shown in FIG. 17;

FIG. 20 is a left side view of the frame shown in FIG. 17;

FIG. 21 is a front view of the frame shown in FIG. 17;

FIG. 22 is a rear view of the frame shown in FIG. 17;

FIG. 23 is a top view of the frame shown in FIG. 17;

FIG. 24 is a bottom view of the frame shown in FIG. 17;

FIG. 25 is a perspective view of still another exemplary frame;

FIG. 26 is another perspective view of the frame shown in FIG. 25;

FIG. 27 is a right side view of the frame shown in FIG. 25;

FIG. 28 is a left side view of the frame shown in FIG. 25;

FIG. 29 is a front view of the frame shown in FIG. 25;

FIG. 30 is a rear view of the frame shown in FIG. 25;

FIG. 31 is a top view of the frame shown in FIG. 25;

FIG. 32 is a bottom view of the frame shown in FIG. 25;

FIG. 33 is a perspective view of an exemplary frame and an exemplary face mask;

FIG. 34 is another perspective view of the frame and face mask shown in FIG. 33;

FIG. 35 is a right side view of the frame and face mask shown in FIG. 33;

FIG. 36 is a left side view of the frame and face mask shown in FIG. 33;

FIG. 37 is a front view of the frame and face mask shown in FIG. 33;

FIG. 38 is a rear view of the frame and face mask shown in FIG. 33;

FIG. 39 is a top view of the frame and face mask shown in FIG. 33;

FIG. 40 is a bottom view of the frame and face mask shown in FIG. 33;

FIG. 41 is a perspective view of yet another exemplary frame;

FIG. 42 is another perspective view of the frame shown in FIG. 41;

FIG. 43 is a right side view of the frame shown in FIG. 41;

FIG. 44 is a left side view of the frame shown in FIG. 41;

FIG. 45 is a front view of the frame shown in FIG. 41;

FIG. 46 is a rear view of the frame shown in FIG. 41;

FIG. 47 is a top view of the frame shown in FIG. 41;

FIG. 48 is a bottom view of the frame shown in FIG. 41;

FIG. 49 is a front view of a portion of an exemplary face mask;

FIG. 50 is a front view of a portion of an exemplary face mask;

FIG. 51 is a perspective view of another exemplary frame and another exemplary face mask;

FIG. 52 is another perspective view of the frame and face mask shown in FIG. 51;

FIG. 53 is a right side view of the frame and face mask shown in FIG. 51;

FIG. 54 is a left side view of the frame and face mask shown in FIG. 51;

FIG. 55 is a front view of the frame and face mask shown in FIG. 51;

FIG. 56 is a rear view of the frame and face mask shown in FIG. 51;

FIG. 57 is a top view of the frame and face mask shown in FIG. 51; and

FIG. 58 is a bottom view of the frame and face mask shown in FIG. 51.

### DESCRIPTION OF EXAMPLE EMBODIMENTS

The present invention is generally directed towards a frame, such as an eyeglass-type frame, and/or face mask. The principles of the present invention, however, are not limited to frames and/or face masks. It will be understood that, in light of the present disclosure, the disclosed frame and/or face mask can be successfully used in connection with other types of structures and devices.

Additionally, to assist in the description of the frame and/or face mask, words such as top, bottom, front, rear, right and left are used to describe the accompanying figures. It will be appreciated, however, that the present invention can be viewed in a variety of desired positions, including various angles and orientations.

It will also be appreciated that the singular forms “a”, “an”, and “the” may include plural forms as well, depending, for example, upon context. It will be further appreciated that the terms “comprises”, “comprising”, “including”, and “having” may be inclusive and may specify the presence of stated features, steps, operations, elements, and/or components, but do not preclude the presence or addition of one or more other features, steps, operations, elements, components, and/or groups thereof. In addition, the wording “and/or” can include any and all combinations of one or more of the associated and/or listed items.

Spatially relative terms, such as “inner”, “outer”, “beneath”, “below”, “lower”, “above”, “upper”, and the like, may be used for ease of description to describe one or more elements, and/or a relationship to another element(s) or feature(s). Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features depending, for example, upon context. Thus, the example term “below” can encompass both an orientation of above and below. The device may be otherwise oriented (e.g., rotated 90 degrees or at other orientations) and the spatially relative descriptors may be interpreted accordingly. It will be understood that phrases such as “between X and Y” may be interpreted to include X and Y. And phrases such as “from X to Y” may be interpreted to include X and Y.

It will also be understood that wording such as “on”, “attached”, “connected”, etc. may indicate one or more elements are directly on, attached, or connected, and/or one or more intervening elements may also be present. In contrast, when an element is referred to as being, for example, “directly attached to” another element, no intervening elements may be present. It will further be understood that references to a structure or feature that is disposed “adjacent” to another structure or feature may not have portions that touch, overlap, or underlie the adjacent feature.

In addition, it will be understood that wording such as “first”, “second”, etc. may be used to describe various elements, but these elements should not necessarily be limited by these terms. For example, these terms may be used to distinguish one element from another. Thus, a “first” element could also be termed a “second” element without departing from the teachings of the present disclosure. Additionally, a sequence or process, such as one or more steps, may not be limited to the specific order listed depending upon context. Further, the disclosure may include any number of features, aspects, advantages, and the like, in any combination, and one or more of the features, aspects, advantages, and the like may not be present, needed, or required, The present disclosure could also include one or more additional features, aspects, advantages, and the like depending, for example, upon the intended use.

In the exemplary embodiments illustrated in the figures, like structures may be provided with similar reference designations for convenience and readability. It will be understood that no limitation of the scope of the disclosure may be intended. It will also be understood that the language used to describe the exemplary embodiments is illustrative only and is not to be construed as limiting the scope of the disclosure.

The various features illustrated in the drawings may be drawn to scale, but not necessarily. Further, the drawings may be simplified for clarity and the drawings may not depict all of the features, components, or the like.

The frame and face mask may be used together. The frame and/or face mask can also be used independently and/or in connection with other structures, devices, and the like. Thus, while wording such as frame and face mask may be used for convenience and/or readability, it will be understood that the frame and/or face mask can be used separately or autonomously, in combination, and in connection with other parts, components, structures, and/or devices. Further, the frame and/or face mask may be part of a unitary, one-piece structure, and the frame and/or face mask may include one or more parts and/or components.

In some circumstances, example embodiments of the frame and/or face mask may provide a wearer greater comfort by removing or eliminating parts of conventional face masks such as the ties or straps that go around the ears, head, and/or neck of the wearer. Alternatively, and/or additionally, example embodiments of the frame and face mask may reduce pressure on sensitive areas of the wearer's face by attaching the face mask to the frame. Advantageously, the frame may be worn, and distribute pressure, similar to conventional eyeglasses. The frame may be quick, easy, and intuitive for the wearer to put on and take off because it may be similar to wearing conventional eyeglasses.

In some circumstances, the effectiveness of the face mask may be increased by reducing movement of the face mask on the wearer's face. Reducing movement may contribute to better coverage of the wearer's nose and mouth by the face mask. Alternatively, and/or additionally, the reduced movement of the face mask may contribute to reduced face touching by the wearer, which may increase the effectiveness of the face mask. In addition, in some exemplary embodiments, a large pocket may be disposed between the face mask and the wearer's face. The large pocket may reduce contact between the face mask and the wearer's face, which may increase comfort and/or breathability.

In some circumstances, example embodiments of the frame and/or face mask may provide a better field of view and/or peripheral vision to the wearer. For example, the frame and/or face mask may not limit the field of view and/or peripheral vision to the wearer. The frame and/or face mask may also be sized and configured to only block or obstruct a limited portion of the field of view and/or peripheral vision to the wearer. Advantageously, because the frame and/or face mask may reduce the field of view and/or peripheral vision of the wearer a relatively small amount or none at all, the frame and/or face mask may be used in a variety of settings and environments.

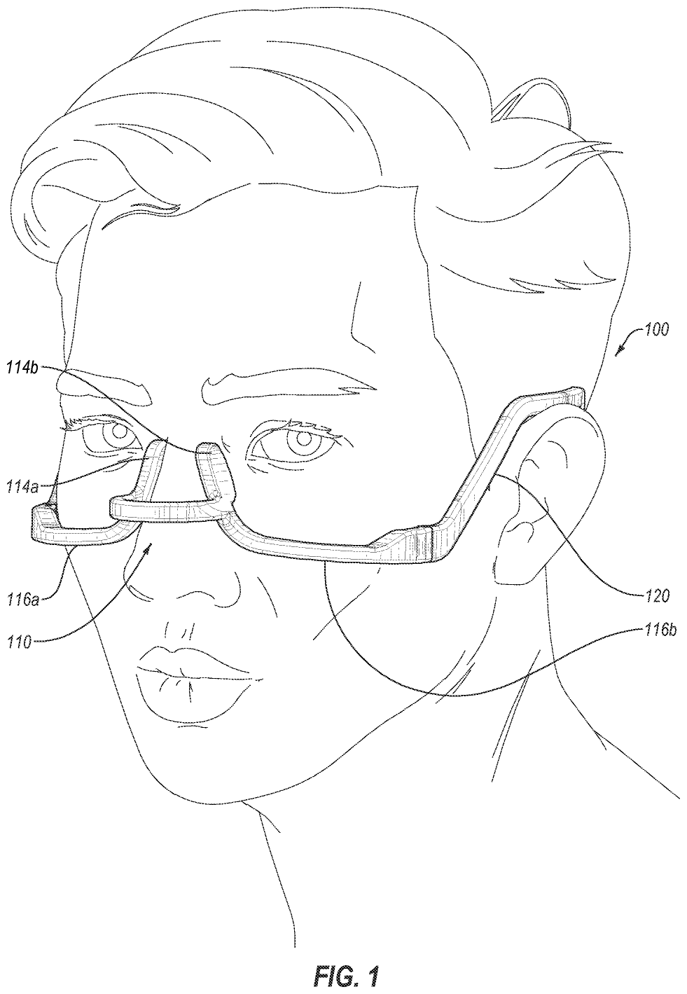

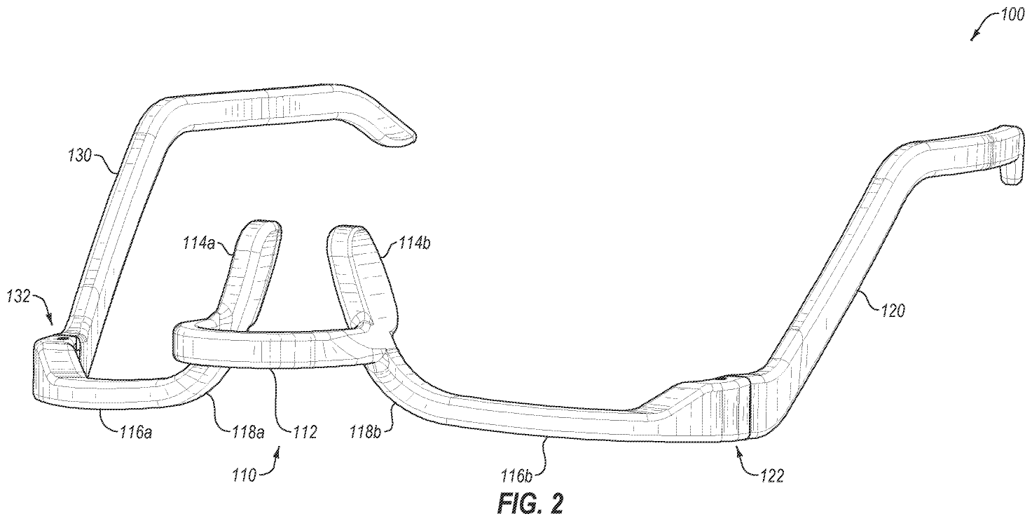

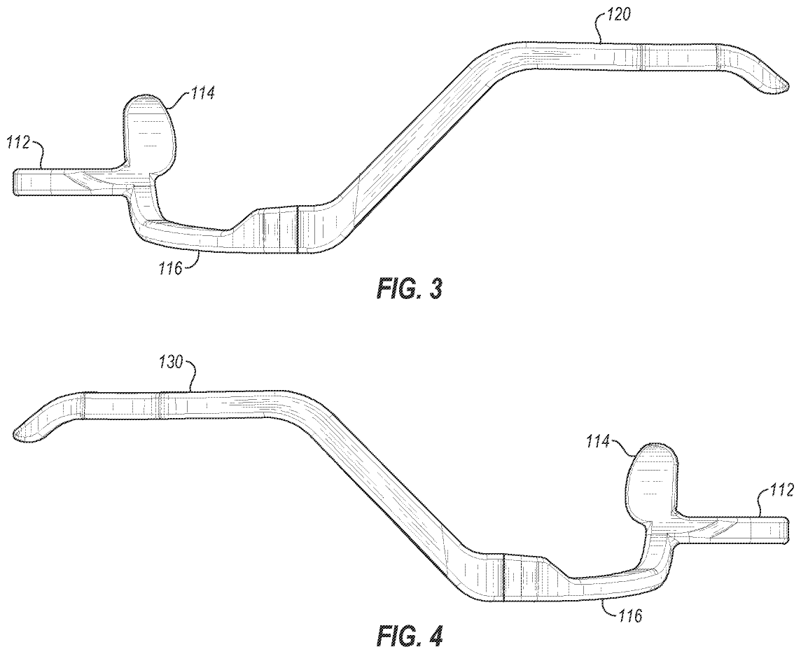

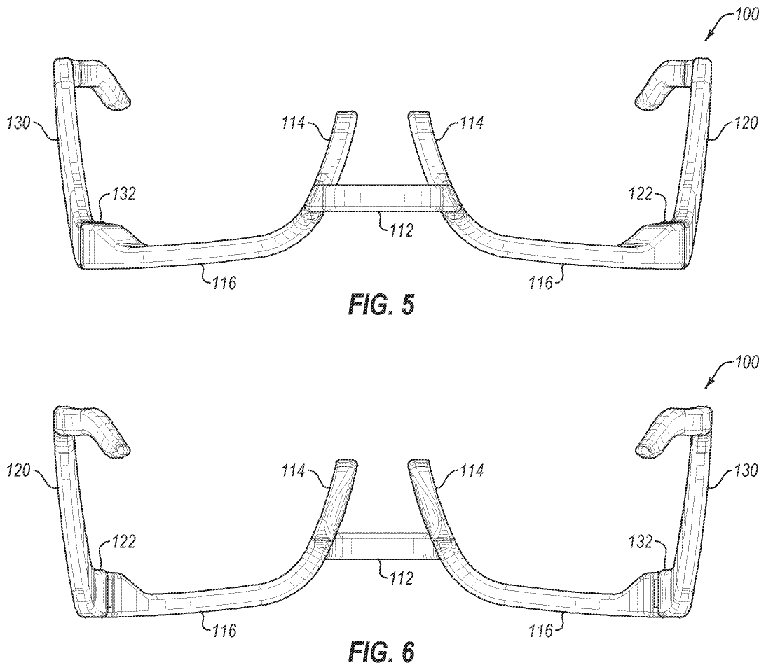

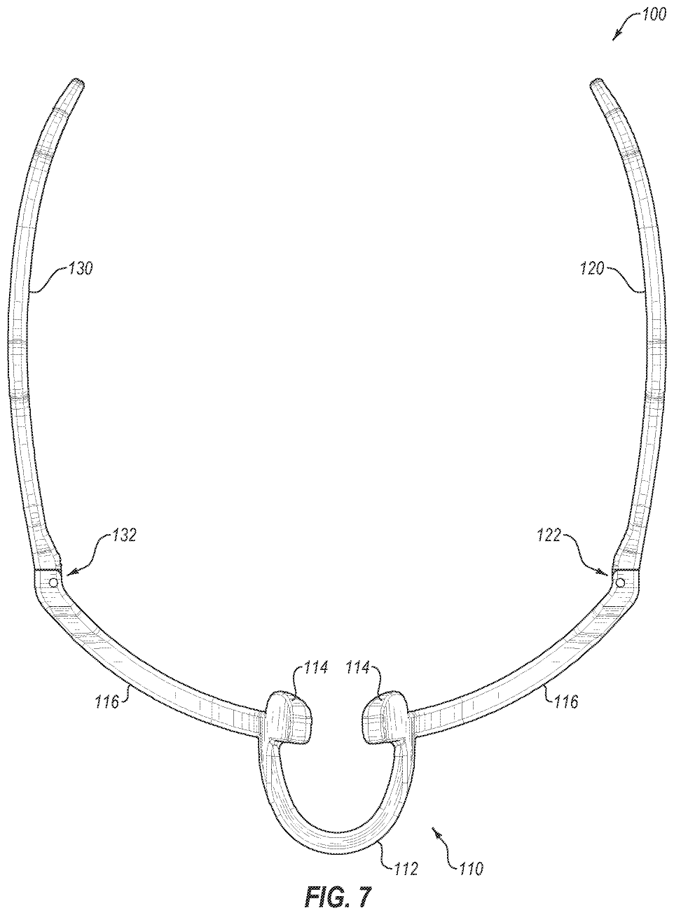

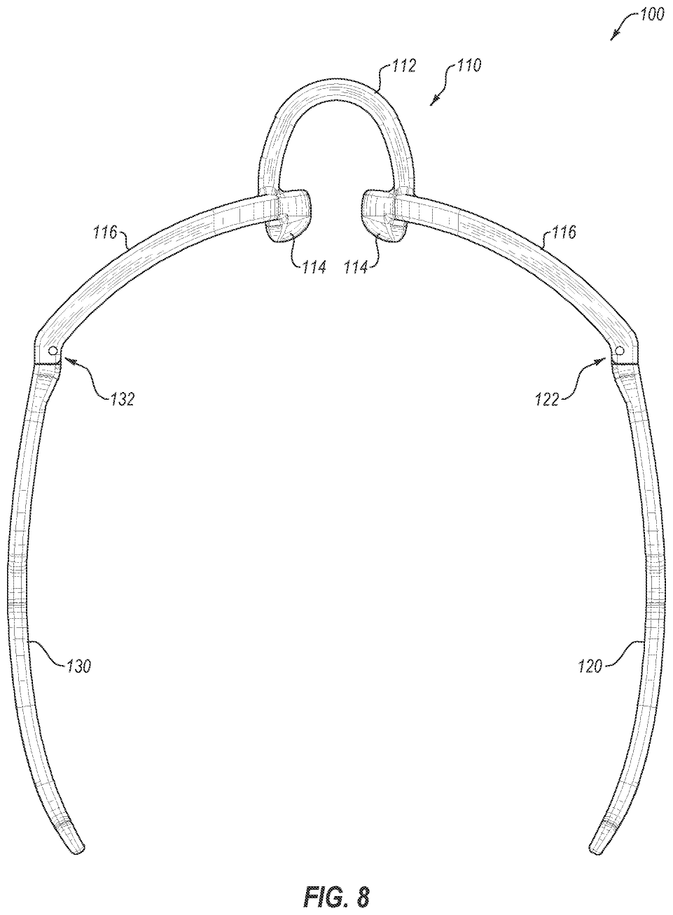

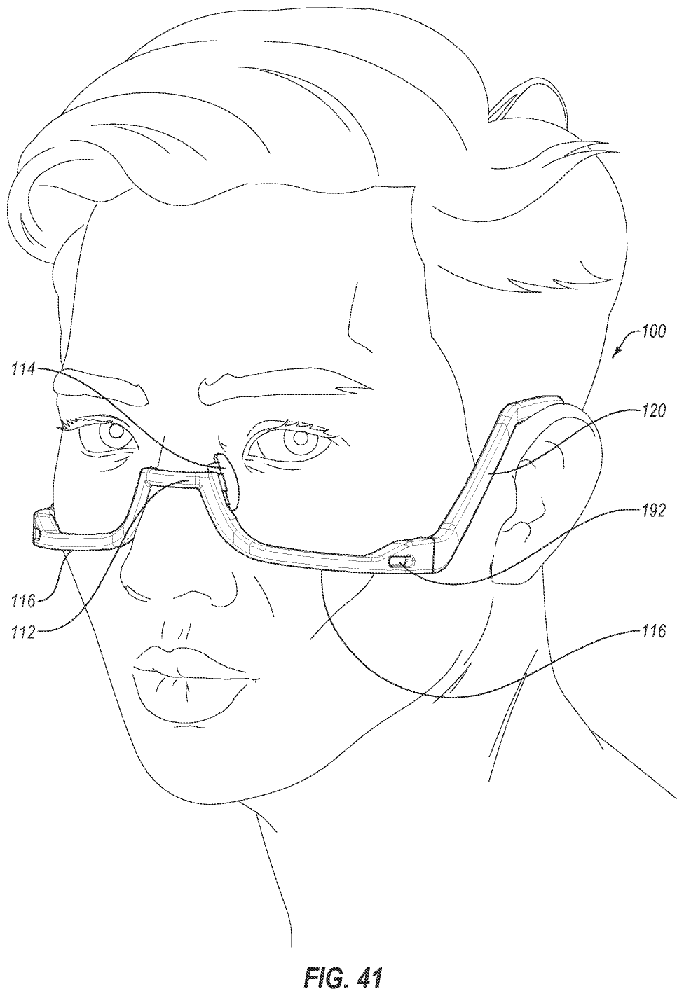

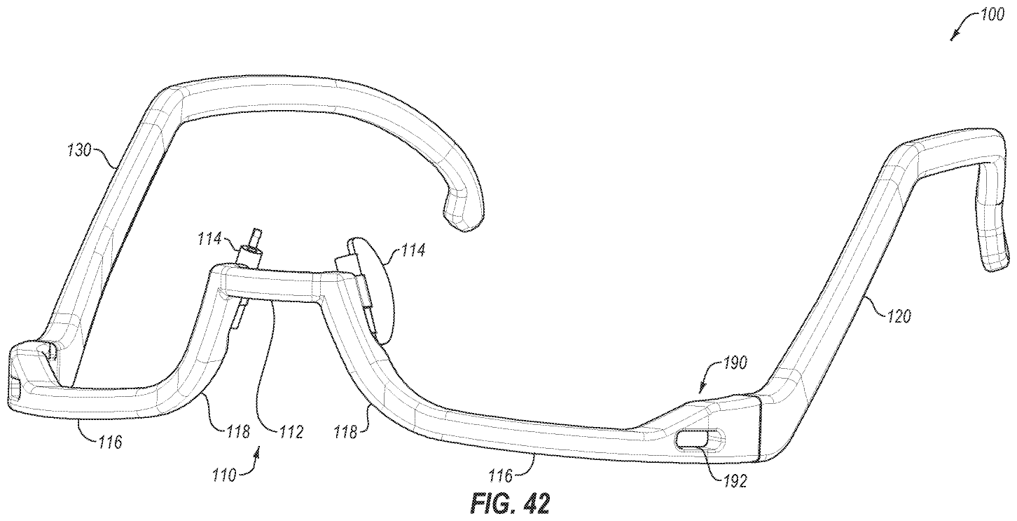

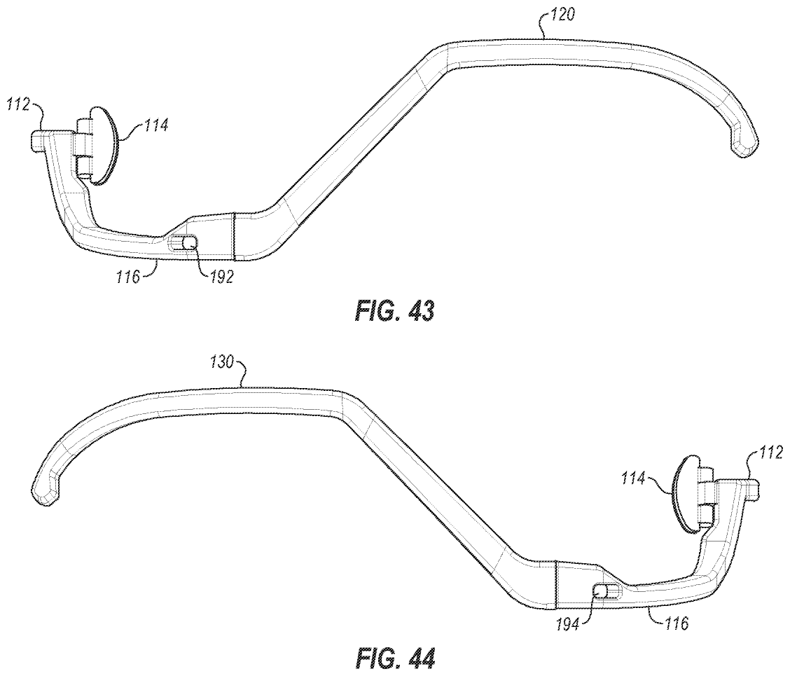

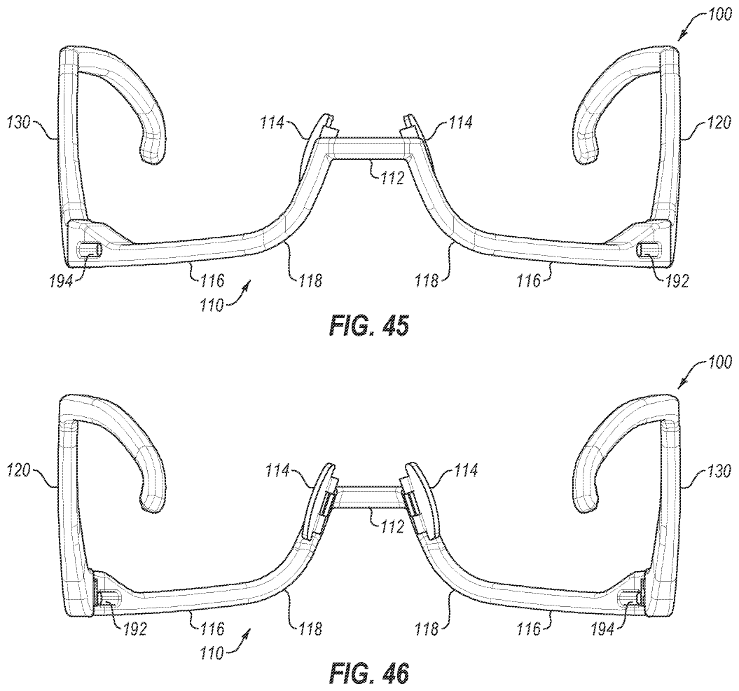

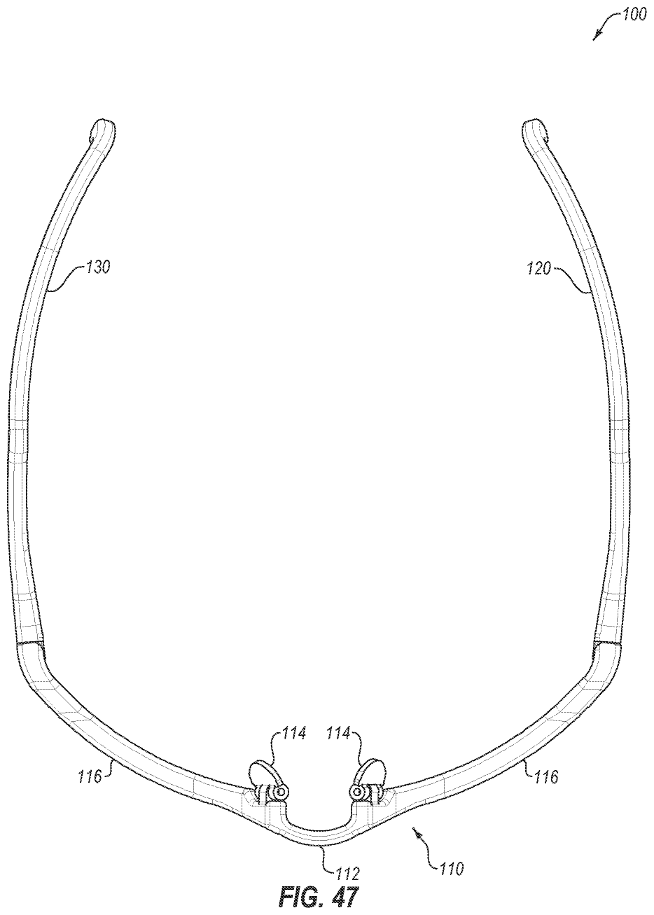

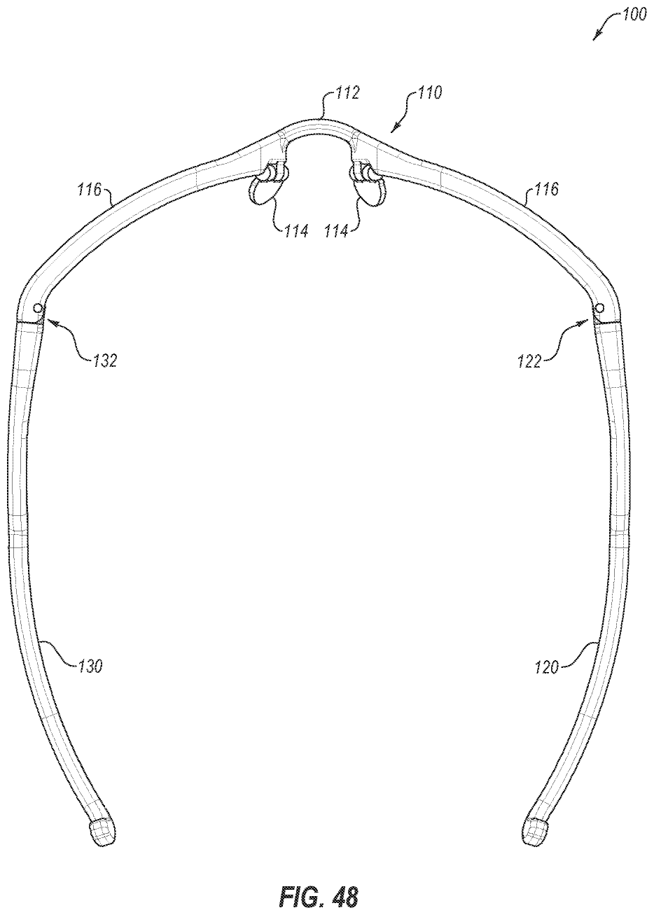

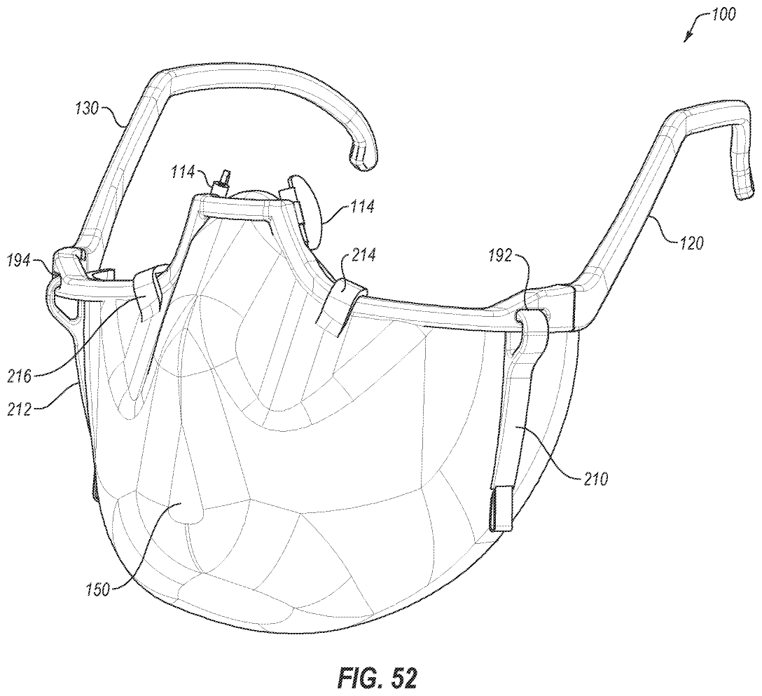

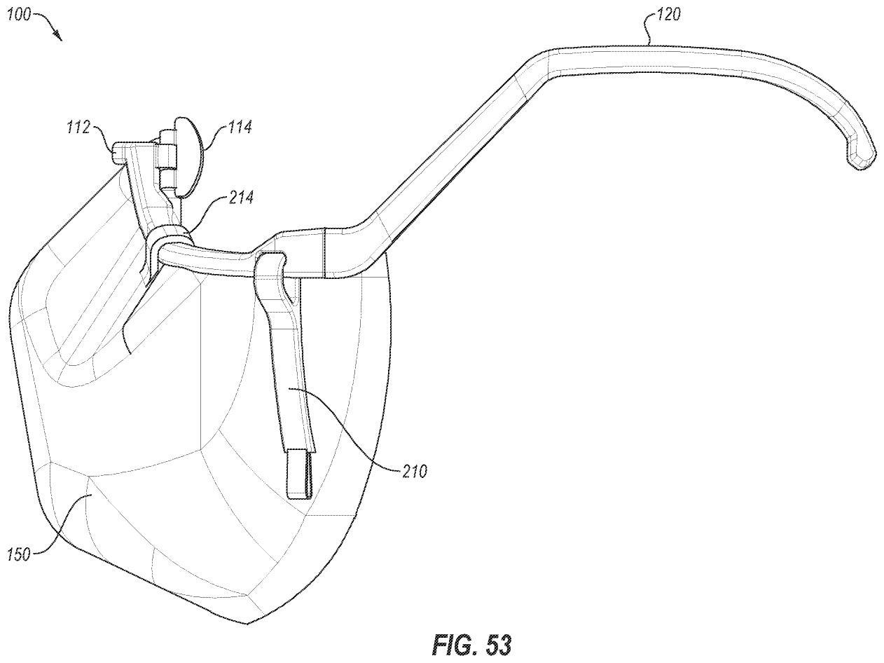

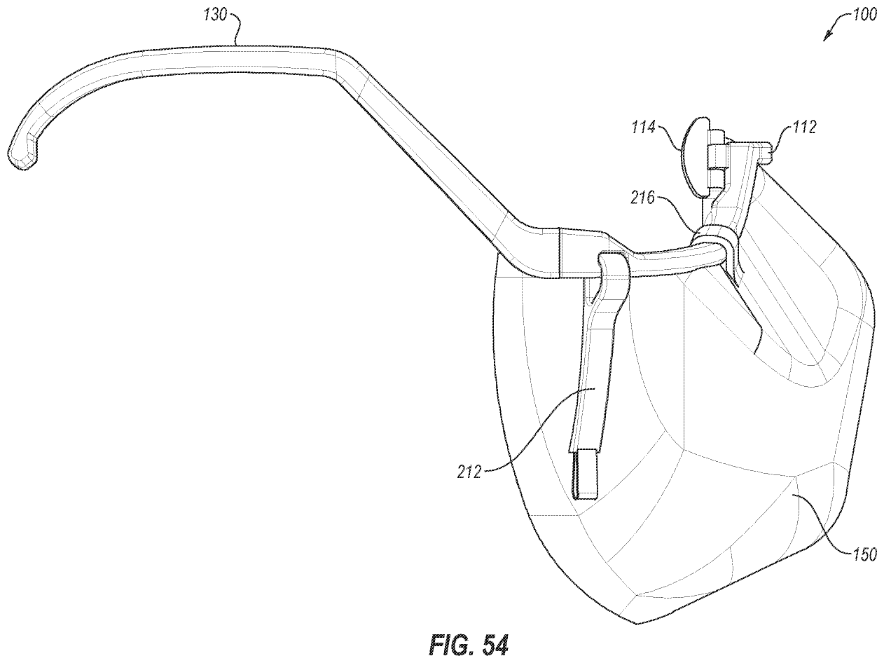

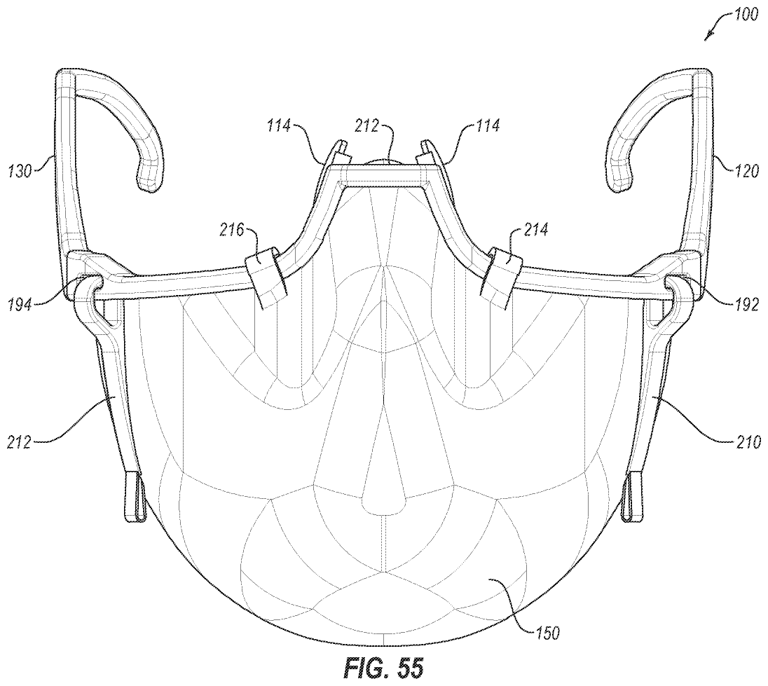

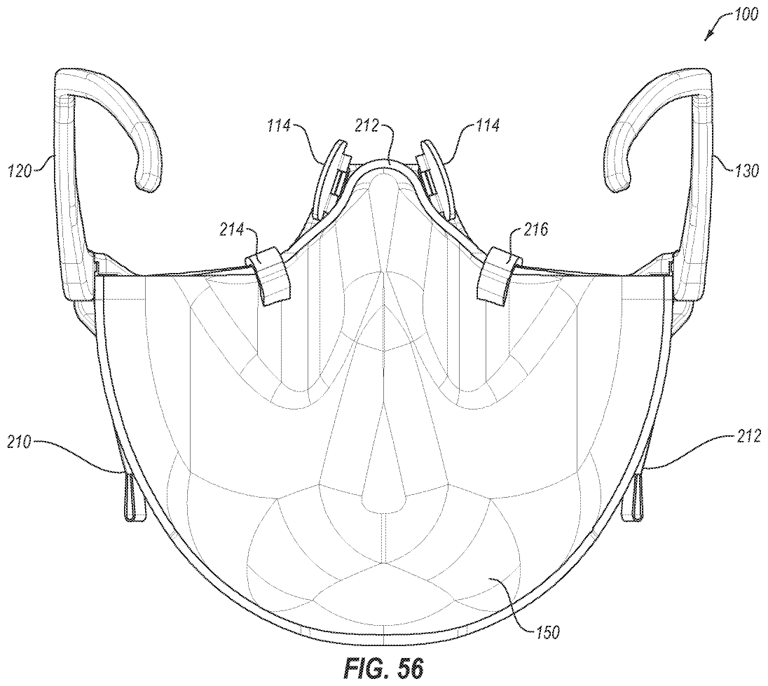

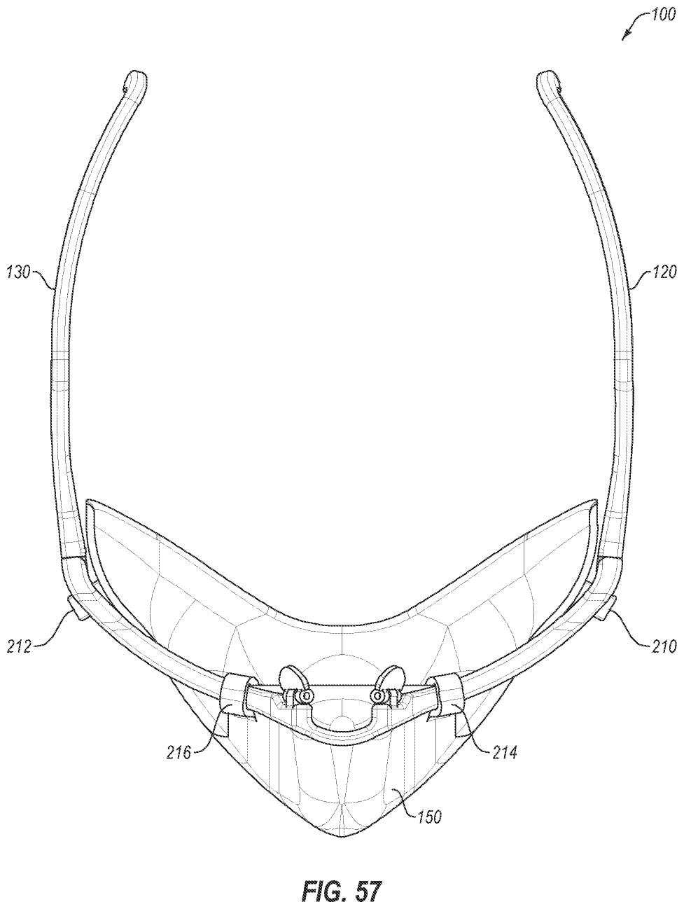

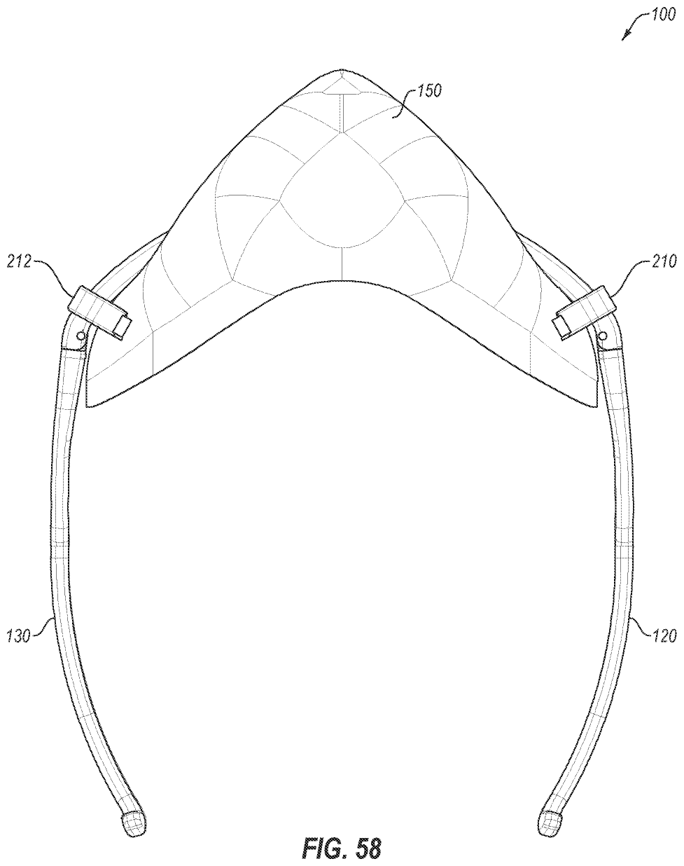

FIGS. 1-8 illustrate an exemplary embodiment of a frame 100. As shown in the accompanying figures, the frame 100 may have an eyeglasses-like configuration. For example, the frame 100 may include a central section 110, a left temple section 120, a first hinge 122, a right temple section 130, and a second hinge 132. The first hinge 122 may connect the central section 110 and the left temple section 120, and the second hinge 132 may interconnect the central section 110 and the right temple section 130. The central section 110 may include a bridge portion 112, a first nose pad 114a, a second nose pad 114b (which may be collectively or individually referred to as a nose pad or nose pads 114), a first cheek portion 116a, and/or a second cheek portion 116b (which may be collectively or individually referred to as a cheek portion or cheek portions 116). The nose pad 114 may be part of the frame 100 and/or the nose pad 114 may be attached to the frame 100. For example, the nose pad 114 may be an enlarged part of the frame 100, such as shown in some of the accompanying figures. Additionally, and/or alternatively, the nose pad 114 may be attached to the frame, such as shown in FIGS. 41-48 and 51-58.

In some embodiments, the central section 110 of the frame 100 may be generally horizontally disposed, and the central section 110 may be configured to horizontally traverse at least a portion of the wearer's face. For example, the central section 110 may include the first cheek portion 116a and the second cheek portion 116b, and the cheek portions 116 may be generally horizontally disposed and the cheek portions may extend across at least a portion of the wearer's cheeks. The central section 110 may include the bridge portion 112, and the bridge portion 112 may be connected to the cheek portions 116. For example, a first connecting portion 118a may connect the first cheek portion 116a and the bridge portion 112 and/or the first nose pad 114a, and a second connecting portion 118b may connect the second cheek portion 116b and the bridge portion 112 and/or the second nose pad 114b. The first and second connecting portions 118a, 118b (which may be collectively or individually referred to as the connecting portion or connecting portions 118) may at least partially extend upwardly and/or be generally vertically disposed.

As shown in FIGS. 1-8, at least a portion of the bridge portion 112 may be generally horizontally disposed and may traverse at least a portion of the wearer's nose. For example, the bridge portion 112 may extend outwardly and may have a generally U-shaped configuration, which may allow the bridge portion 112 to traverse the wearer's nose.

In some embodiments, at least a portion of the central section 110, such as the lateral ends, may be disposed below the zygomatic bone (cheek bone) of the wearer. In these and other embodiments, one or more portions of the central section 110 may be configured to be removed and/or substantially removed from the wearer's field of view and/or peripheral vision. For example, the cheek portions 116 may be located low enough on the wearer's face that the cheek portions 116 are substantially or fully removed from the wearer's field of view and/or peripheral vision. Alternatively, and/or additionally, in some embodiments, the lateral ends of the central section 110 may include vertical portions and the vertical portions may elevate the junction between the central section 110 and the temple sections 120, 130. For instance, the vertical portions may elevate the junction between the central section 110 and the temple sections 120, 130 to an approximate eye level.

In some embodiments, the bridge portion 112 may be located medially on the central section 110 of the frame 100. In some embodiments, the bridge portion 112 may be located proximate or closer to the wearer's eyes than the cheek portions 116. For example, the bridge portion 112 may be generally aligned with a lower portion, a middle portion, and/or an upper portion of the wearer's eyes. Alternatively, and/or additionally, the bridge portion 112 may be disposed proximate or closer to the cheek portions 116, and/or the bridge portion 112 may be disposed below the wearer's eyes. For instance, the bridge portion 112 may be linear or substantially linear with the cheek portions 116. In an exemplary embodiment, the bridge portion 112 may be at least substantially disposed between the cheek portions 116 and the lower portion of the wearer's eyes. In these and other embodiments, the bridge portion 112 may be configured to traverse a bottom portion of the wearer's nose or nasal bone. Alternatively, and/or additionally, the bridge portion 112 may cross the wearer's nose at a higher or lower point than the bottom portion of the nose or nasal bone. For example, in instances in which the bridge portion 112 is continuous or substantially continuous with the cheek portions 116 of the central section 110, the bridge portion 112 may cross the wearer's nose over the soft, cartilage portion. In another example, in instances in which the bridge portion 112 is elevated above the cheek portions 116 of the central section 110, the bridge portion 112 may cross the wearer's nose between the wearer's eyes.

In some embodiments, the first nose pad 114a and the second nose pad 114b may be attached to the bridge portion 112, the cheek portions 116, and/or the connecting portions 118. For example, the nose pads 114 may be connected to and/or may extend outwardly from the bridge portion 112, the cheek portions 116, and/or the connecting portions 118. Alternatively, and/or additionally, the nose pads 114 may include separate components that may be attached to the bridge portion 112, the cheek portions 116, and/or the connecting portions 118. For example, the nose pads 114 may be attached to the bridge portion 112, the cheek portions 116, and/or the connecting portions 118 such as by bonding with heat and/or a chemical process, an adhesive, mechanical fasteners, such as screws, and other suitable attachment mechanisms. The nose pads 114 may also be connected to other portions of the frame 100.

In some embodiments, the nose pads 114 may be sized and configured to rest on the wearer's nose, such as on the nasal bone, which may be analogous to conventional eyeglass frames. The nose pads 114 may also be sized and configured to contact other portions of the wearer's nose and/or face.

As shown in the accompanying figures, the bridge portion 112 may be at least substantially disposed below the nose pads 114. The bridge portion 112 may also be aligned with a portion of the nose pads 114, such as the lower portion of the nose pads. Additionally, the bridge portion 112 may be at least substantially disposed between the nose pads 114 and the cheek portions 116. The bridge portion 112, the nose pads 114, and the cheek portions 116 may be disposed in a generally vertically aligned and/or stacked configuration. For example, the cheek portions 116 may be disposed in a lower portion of the frame 100. The bridge portion 112 may be disposed above the cheek portions 116, and the nose pads 114 may be disposed entirely, at least substantially, or at least partially above the bridge portion 112.

As shown in FIGS. 1, 4, and 5, for example, the cheek portions 116 may slope downwardly towards the hinges 122, 132, and the hinges 122, 132 may be disposed in a lower portion of the frame 100. Thus, a midpoint of the hinges 122, 132 may be disposed below a midpoint of the cheek portions 116.

The cheek portions 116 may slope upwardly towards the bridge portion 112, the nose pads 114, and/or the connecting portions 118. The cheek portions 116 may be curved, for example, to follow the curvature of the cheeks of the wearer. At least a portion of the cheek portions 116 may be disposed in a generally horizontal plane. For example, a center section of the cheek portions 116 may be disposed in a generally horizontal plane. In an exemplary embodiment, the cheek portions 116 may extend downwardly towards the hinges 122, 132, which may form lowermost portions of the frame 100, and upwardly towards the bridge portion 112, the nose pads 114, and/or the connecting portions 118. A midpoint of the cheek portions 116 may be disposed below a midpoint of the nose pads 114. In an exemplary embodiment, the bridge portion 112 may be disposed between the midpoint of the nose pads 114 and the midpoint of the cheek portions 116

The bridge portion 112, the nose pads 114, the cheek portions 116, and/or the connecting portions 118 may be part of a unitary, one-piece structure, or one or more of these components may be separate structures. For example, the nose pads 114 may be part of the connecting portions 118. Thus, the nose pads 114 may be at least partially formed by an upper portion of the connecting portions 118. Additionally, and/or alternatively, the nose pads 114 may be a different part or component that may be connected to the connecting portions 118 or other suitable portions of the frame 100.

In some embodiments, the lateral ends of the central section 110 may include a hinge, such as the first hinge 122, and the first hinge may be disposed on the left lateral end of the central section 110. The central section 110 may also include the second hinge 132 and the second hinge may be disposed on the right lateral end of the central section 110. In some embodiments, the first hinge 122 and the second hinge 132 may include standard eyeglass hinges or spring eyeglass hinges. Alternatively, and/or additionally, the junctions between the central section 110 and the left temple section 120 and the right temple section 130 may include hingeless connections. For example, the left temple section 120 and the right temple section 130 may attach to the central section 110 with a durable material that may be arranged to fit the wearer's head. The durable material may include titanium and/or other similarly durable materials.

In some embodiments, the left temple section 120 may be flush with the left lateral end of the central section 110, such as when the temple section is in an open configuration. In the open configuration, the left temple section 120 may be extended so that it may be positioned on the superior or upper portion of the wearer's ear. In a closed configuration, the left temple section 120 may not be flush with the left lateral end of the central section 110 and a distal end of the left temple section 120 may be pointed in the direction of the opposite hinge, such as the second hinge 132.

Similarly, in some embodiments, the right temple section 130 may be flush with the right lateral end of the central section 110, such as when the temple section is in an open configuration. In the open configuration, the right temple section 130 may be extended so that it may be positioned on the superior or upper portion of the wearer's ear. In a closed configuration, the right temple section 130 may not be flush with the right lateral end of the central section 110 and a distal end of the right temple section 130 may be pointed in the direction of the opposite hinge, such as the first hinge 122.

In some embodiments, the first hinge 122 and the second hinge 132 may be configured to enable the transition of the left temple section 120 and the right temple section 130 between open and closed configurations.

In some embodiments, the left temple section 120 may be configured to be attached to the left lateral end of the central section 110, such as via the first hinge 122. In instances in which the lateral ends of the central section 110 are located below the cheek bone, the left temple section 120 may slope upwardly from the attachment point to the central section 110 to a position superior or above the ear of the wearer. For example, the left temple section 120 may horizontally traverse the side of the wearer's head from the attachment point to the central section 110 to a superior or upper portion of the wearer's ear. In these and other embodiments, the sloped portion may extend upwardly at an angle, such as an angle between approximately 30 and approximately 60 degrees, an angle between approximately 35 and approximately 55 degrees, an angle between approximately 40 and approximately 50 degrees, or at an angle of approximately 45 degrees. In instances in which the lateral ends of the central section 110 include vertical portions, the left temple section 120 may be disposed at a smaller angle and/or may have a substantially straight configuration from the first hinge 122 to a superior portion of the wearer's ear. In instances in which the lateral ends of the central section 110 include vertical portions, the left temple section 120 may be angled upwardly at an angle of about 30 degrees, about 25 degrees, about 20 degrees, about 15 degrees, about 10 degrees, about 5 degrees, or less.

In some embodiments, a portion of the left temple section 120 may be bowed out which may provide a better fit to the wearer's head. In addition, the end of the left temple section 120 may include a downwardly extending hook portion that may contribute to maintaining the frame 100 in place on the wearer's face.

In some embodiments, the right temple section 130 may be configured to be attached to the right lateral end of the central section 110, such as via the second hinge 132. In instances in which the lateral ends of the central section 110 are located below the cheek bone, the right temple section 130 may slope upwardly from the attachment point to the central section 110 to a position superior or upper portion of the ear of the wearer. For example, the right temple section 130 may horizontally traverse the side of the wearer's head from the attachment point to the central section 110 to a superior or upper portion of the wearer's ear. In these and other embodiments, the sloped portion may extend upwardly at an angle, such as an angle between approximately 30 and approximately 60 degrees, an angle between approximately 35 and approximately 55 degrees, an angle between approximately 40 and approximately 50 degrees, or at an angle of approximately 45 degrees. In instances in which the lateral ends of the central section 110 include vertical portions, the right temple section 130 may be disposed at a smaller angle and/or may have a substantially straight configuration from the first hinge 122 to a superior portion of the wearer's ear. In other instances in which the lateral ends of the central section 110 include vertical portions, the right temple section 130 may be angled upwardly at an angle of about 30 degrees, about 25 degrees, about 20 degrees, about 15 degrees, about 10 degrees, about 5 degrees, or less.

In some embodiments, a portion of the right temple section 130 may be bowed out which may provide a better fit to the wearer's head. In some embodiments, the end of the right temple section 130 may include a downwardly extending hook portion that may contribute to maintaining the frame 100 in place on the wearer's face.

In some embodiments, all or a portion of the frame 100 may be constructed from the same material. For example, the central section 110, the left temple section 120, and the right temple section 130 may all be constructed from the same material. Alternatively, and/or additionally, different sections of the frame 100 may be constructed from different materials. For example, the central section 110 may be constructed a first material, and the left and right temple sections 120, 130 may be constructed from a second material. Alternatively, and/or additionally, various elements within the sections may be constructed from different materials. For example, the nose pads 114 may be constructed from different materials than the cheek portions 116 and/or than the bridge portion 112.

In some embodiments, the frame 100 may be constructed from plastic materials such as cellulose acetate, cellulose propionate, or nylon; metal materials such as Monel, titanium, beryllium, stainless steel, or aluminum; and other materials such as wood, bone, or animal horn. The previously listed materials are provided only as an example and other suitable materials may also be used. Further, the frame 100 may include one or more of the listed materials and/or various combinations thereof. Alternatively, and/or additionally, coatings may be applied to the material and/or materials included in the frame 100 which may give the frame 100 different appearances. For example, the frame 100 may include a silver or gold plating which may alter the appearance of the frame while it may maintain the structure and/or durability of a different underlying material.

In some embodiments, the frame 100 may include one or more attachments, coverings, layers, etc. For example, the nose pads 114 may include silicone padding, which may be more comfortable to the wearer. In another example, the ends of the left temple section 120 and the right temple section 130 may include silicone sleeves which may contribute to the overall comfortability of the frame 100 and/or may also help prevent the frame 100 from moving, such as sliding off the wearer's face. It will be appreciated that frame 100 may include other attachments, coverings, layers, materials, and the like depending, for example, upon the intended use of the frame 100.

In some embodiments, the frame 100 may have a generally uniform thickness. For example, the thickness of the central section 110, the bridge portion 112, the nose pads 114, the cheek portions 116, the connecting portions 118, the left temple section 120, and/or the right temple section 130 may be substantially similar.

In some embodiments, the elements of the frame 100 may vary in thickness. For example, one or more of the elements of the frame 100 may be tapered or thinner than other elements of the frame 100. In an exemplary embodiment, the nose pads 114 may be thinner than the remaining elements in the central section 110. Alternatively, and/or additionally, the nose pads 114 may taper, such as from a thickness at least substantially similar to other elements of the frame 100 to a small thickness. In another example, the bridge portion 112 may have a substantially similar thickness to the cheek portions 116, but the bridge portion 112 may have a smaller thickness and/or be tapered. Other portions not specifically listed of the frame 100 may also vary in thickness and that may contribute to the comfortability and improved visibility of the frame 100.

In some embodiments, the frame 100 may include one or more features that facilitate connection of a mask to the frame 100. For example, the frame 100 may include one or more features that are sized and configured to receive, engage, and/or be attached to a portion of a mask. In an exemplary embodiment, the features may be sized and configured to receive portions of a conventional mask, such as the straps or loops that go around the wearer's ears, neck, and/or head. The features could be fasteners (such as clips, cleats, catches, clasps, buckles, buttons, snaps, and the like); structures (such as hooks, openings, or knobs); adhesives; magnets; hook and loop fasteners; and the like that allow the frame and mask to be connected. For instance, a conventional mask, such as a surgical mask or an N95 mask, may be attached to the frame 100 by one or more connecting features. In these and other embodiments, one or more portions of the frame 100, such as the central section 110, the left temple section 120, and/or the right temple section 130, may include one or more features that enable connection of the mask and the frame. In these and other embodiments, the features may enable the wearer to customize the attachment of the mask and/or the frame, and/or the fit of the mask. After reviewing this disclosure, one of ordinary skill in the art will appreciate that the frame 100 may have any suitable number, size, shape, configuration, and/or arrangement of features that facilitate connection of a mask to the frame 100. The features, however, may not be required.

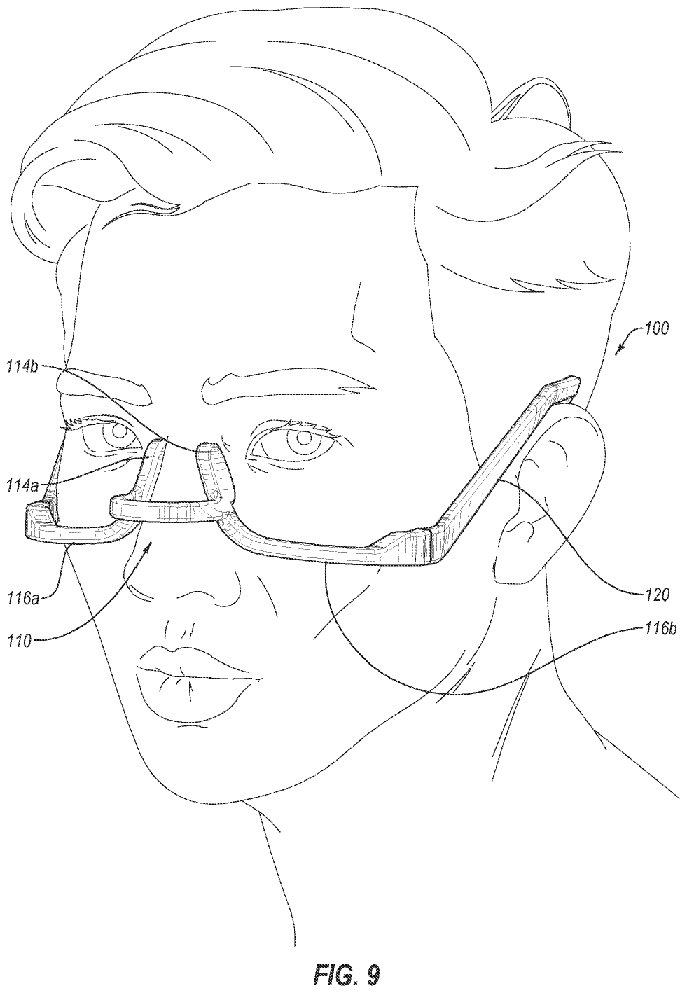

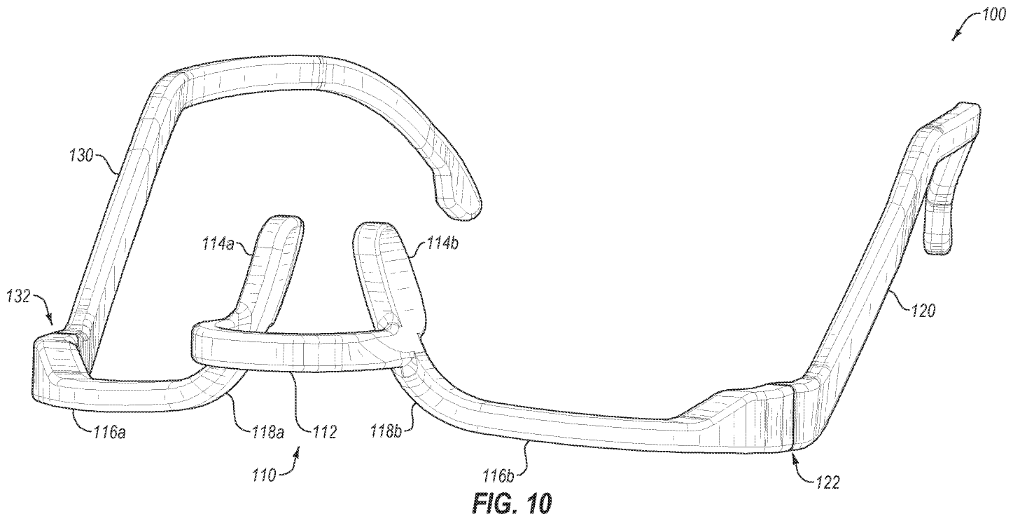

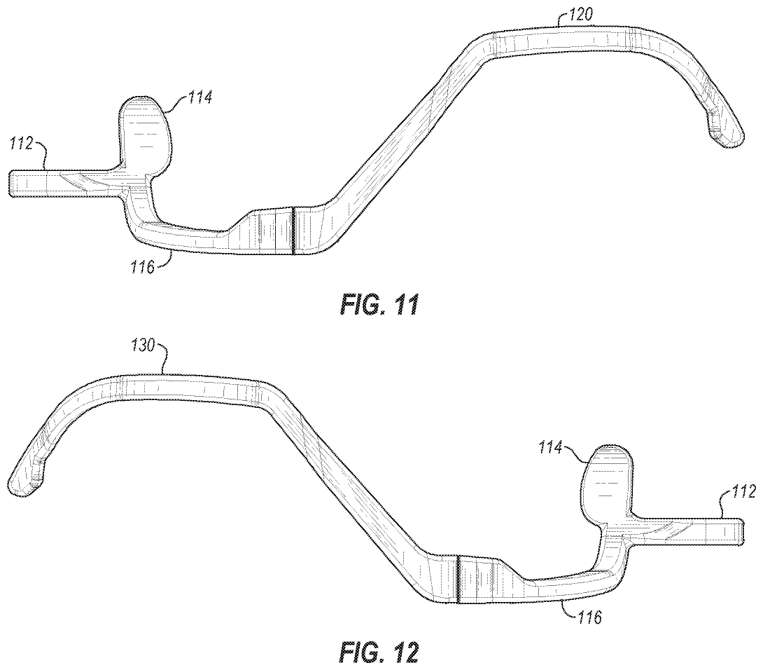

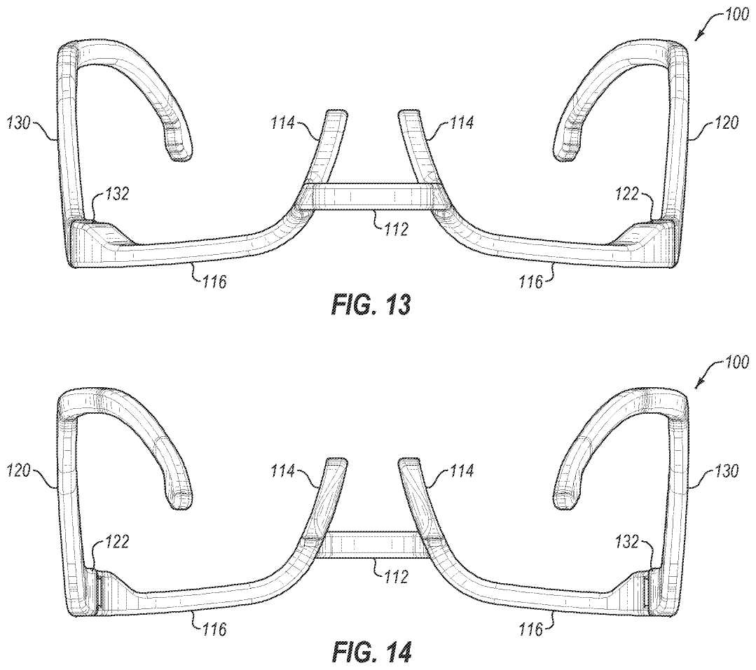

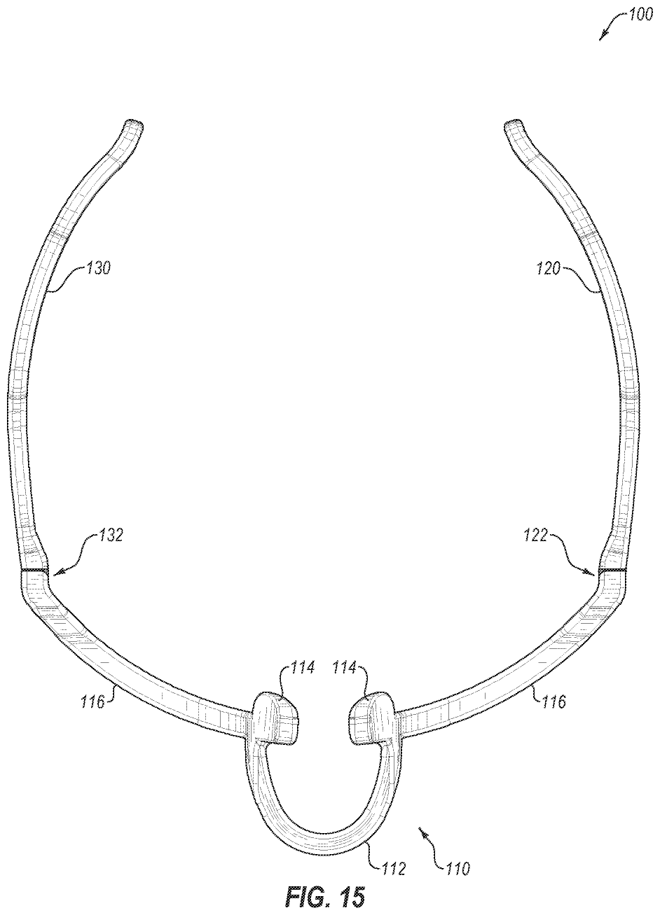

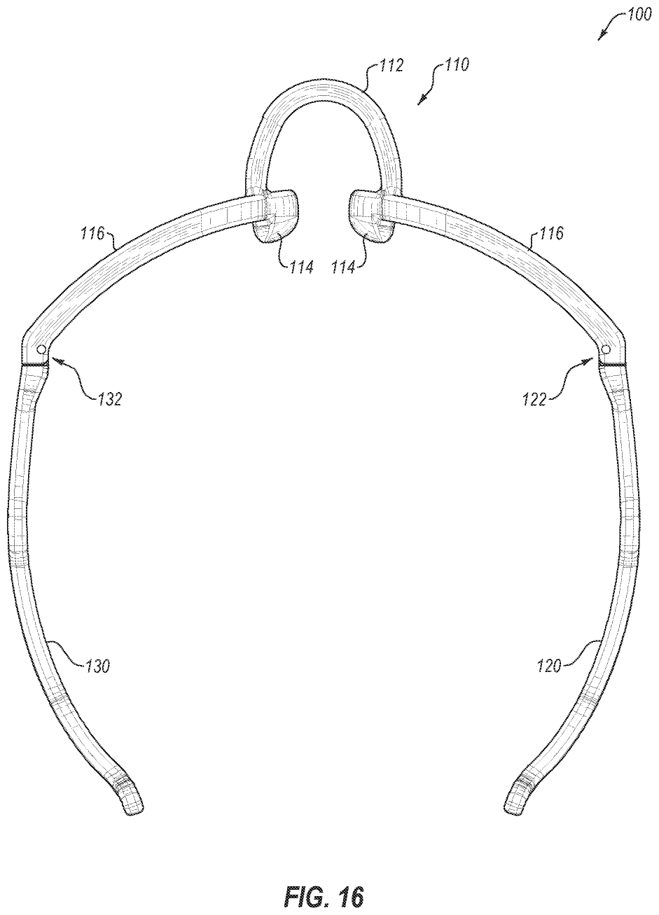

Another exemplary embodiment of the frame 100 is shown in FIGS. 9-16. In this exemplary embodiment, the frame 100 may include the central section 110, the bridge portion 112, the nose pads 114, the cheek portions 116, the connecting portions 118, the temple sections 120, 130, and/or the hinges 122, 132. The temple sections 120, 130, however, may have a different configuration. For instance, the temple sections 120, 130 may be disposed at a different angle, such as about 45 degrees, about 40 degrees, about 30 degrees, about 25 degrees, or less. In addition, the temple sections 120, 130 may have a longer length and/or may be disposed in a generally straight line. For example, the temple sections 120, 130 may extend in a generally straight line from the hinges 122, 132 to a point disposed generally above an upper portion of the wearer's ear. Thus, the temple sections 120, 130 may extend in a generally straight line from a lowermost portion, such as the ends of the central section 110 and/or the hinges 122, 132, to a point above the wearer's ear. Advantageously, the temple sections 120, 130 may provide an increased field of view and/or peripheral vision to the wearer because the temple sections 120, 130 may not be in view of the wearer or may be only slightly in view of the wearer.

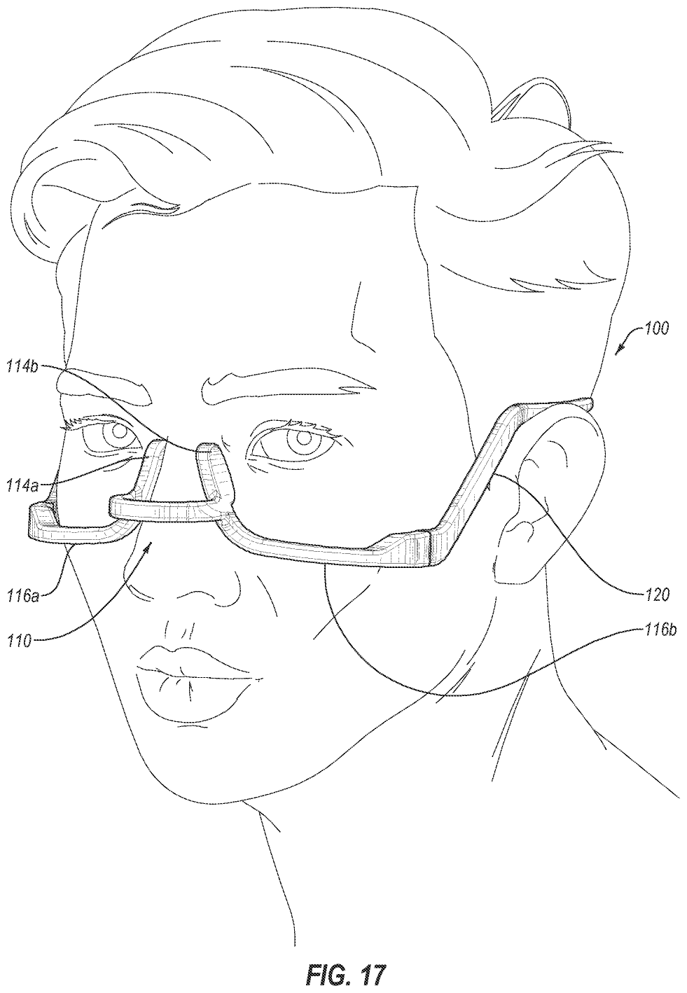

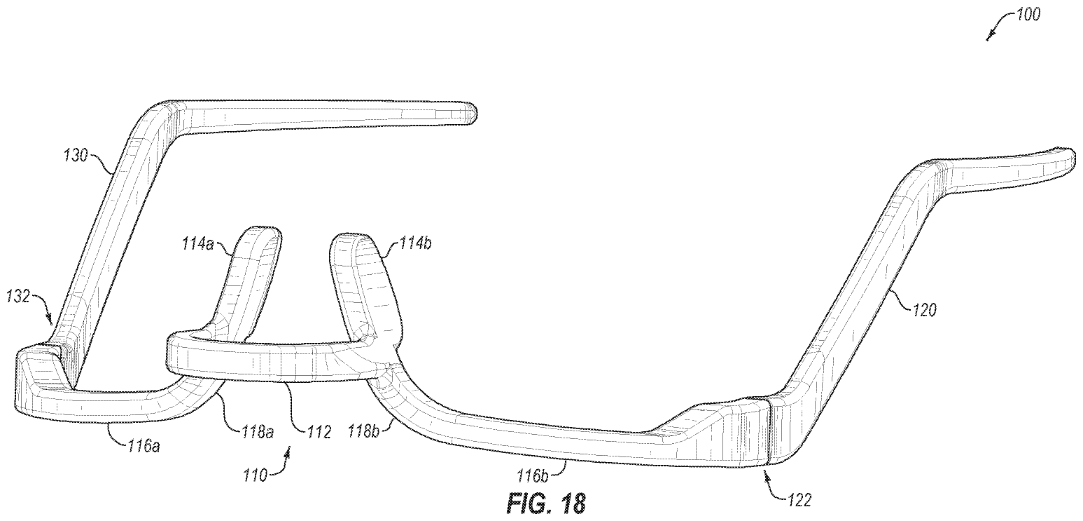

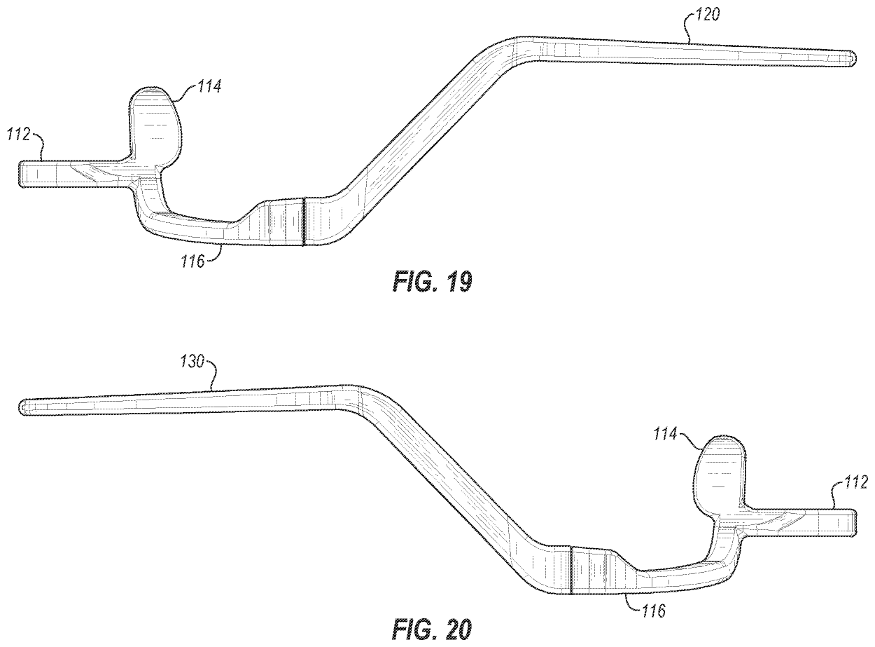

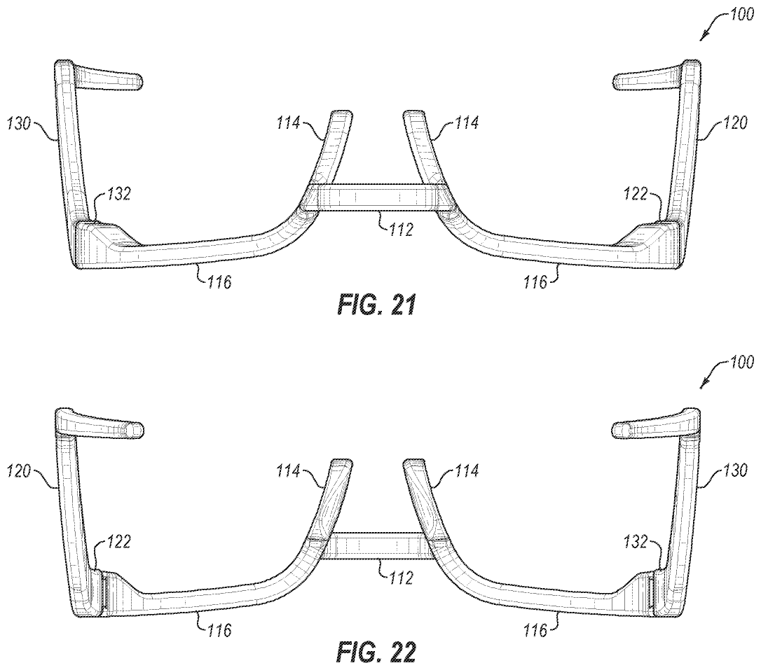

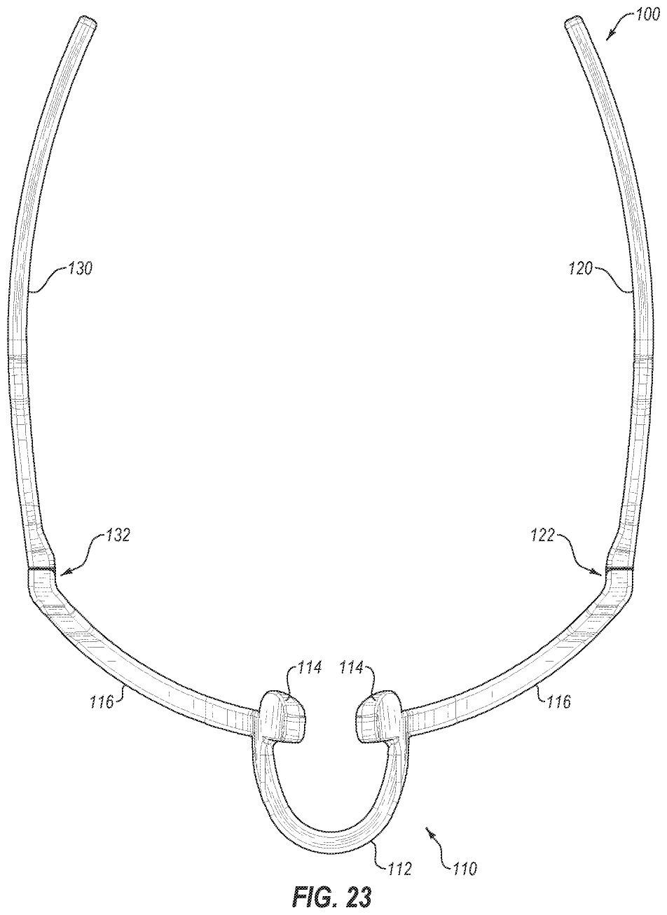

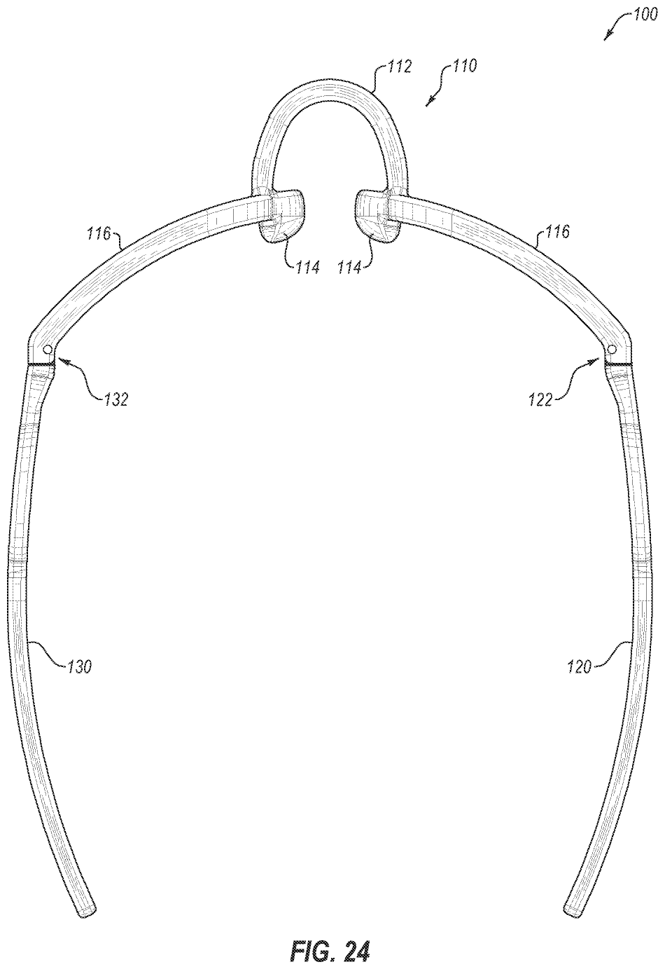

Another exemplary embodiment of the frame 100 is shown in FIGS. 17-24. In this exemplary embodiment, the frame 100 may include the central section 110, the bridge portion 112, the nose pads 114, the cheek portions 116, the connection portions 118, the temple sections 120, 130, and/or the hinges 122, 132. The temple sections 120, 130, however, may have a different configuration. For instance, the temple sections 120, 130 may be disposed at a different angle, such as about 30 degrees, about 35 degrees, about 40 degrees, about 45 degrees, about 50 degrees, about 55 degrees, about 60 degrees, or more. In addition, the temple sections 120, 130 may include an upper portion that has a generally straight or aligned configuration. For example, the temple sections 120, 130 shown in FIGS. 1-8 may include a distal portion that is curved downwardly and/or wraps around a rear portion of the wearer's ear. The temple section 120, 130 shown in FIGS. 17-21 may extend rearwardly in a generally straight line. If desired, a plane generally aligned with the upper portion of the temple section 120, 130 may be disposed generally parallel to a plane aligned with the central section 110, the bridge portion 112, and/or the cheek portions 116.

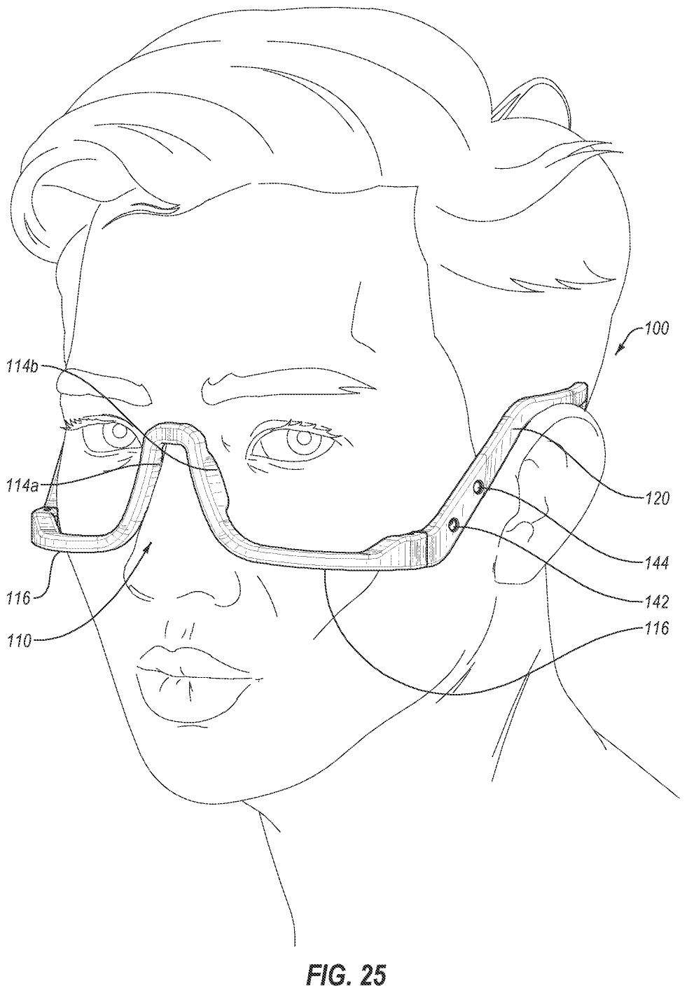

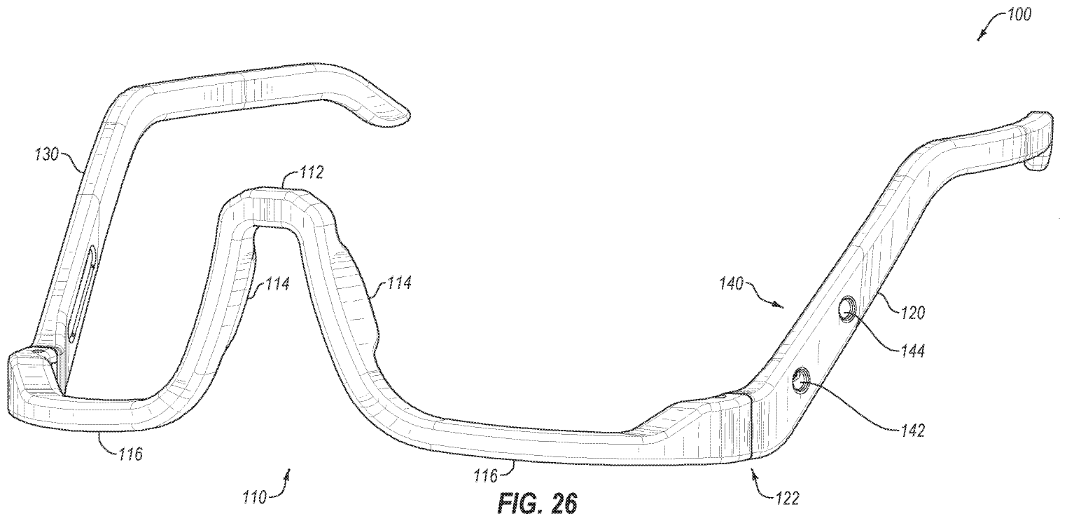

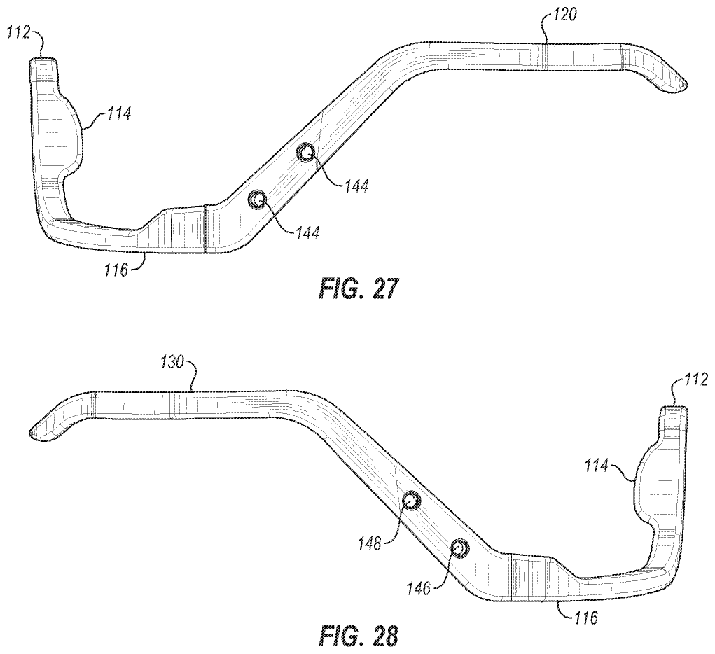

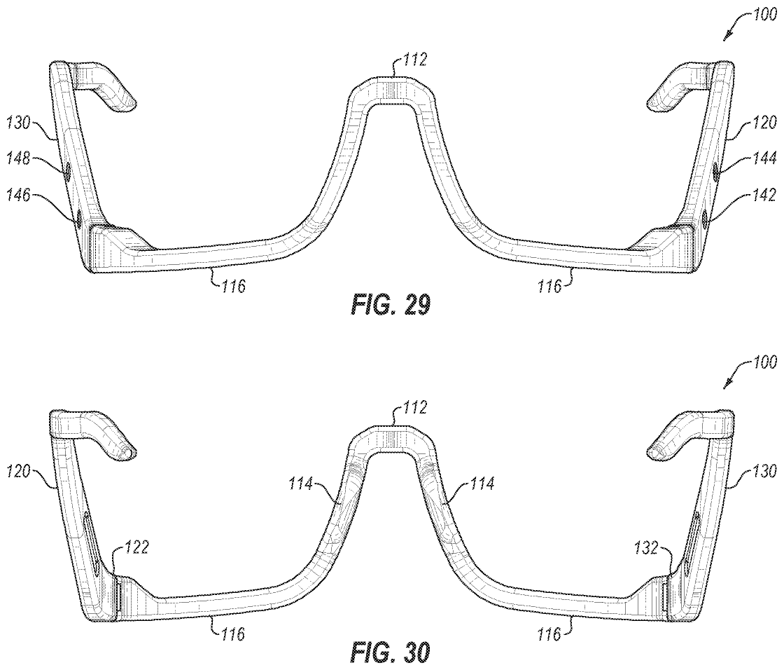

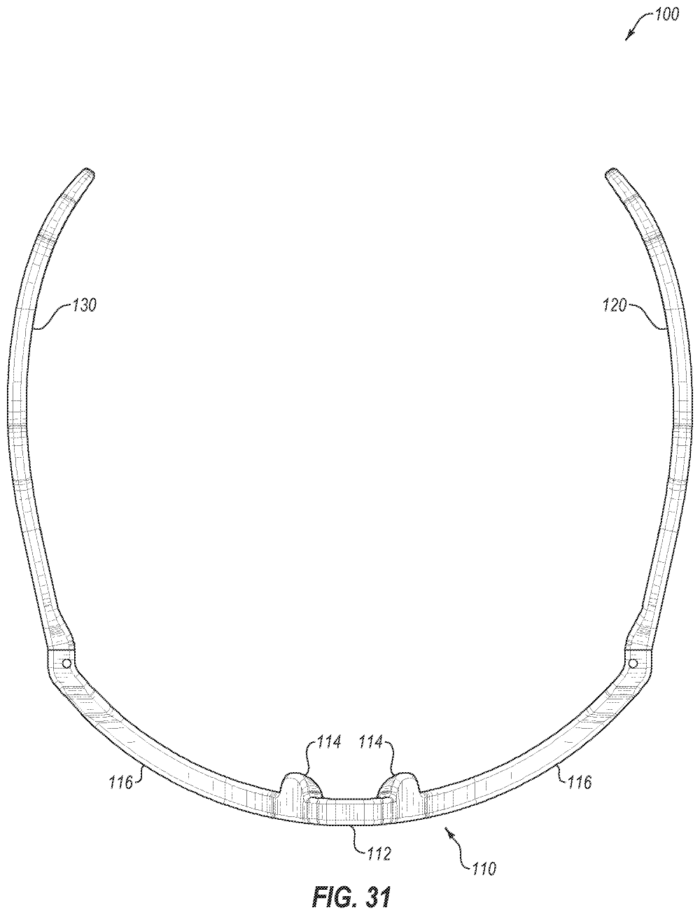

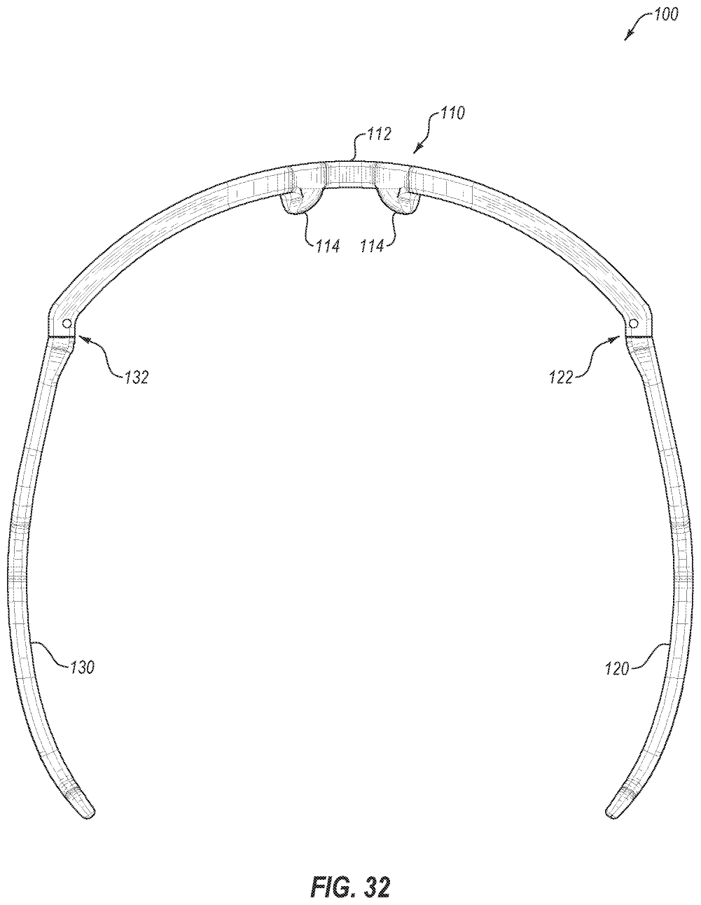

Still another exemplary embodiment of the frame 100 is shown in FIGS. 25-32. In this exemplary embodiment, the frame 100 may include the central section 110, the bridge portion 112, the nose pads 114, the cheek portions 116, the connecting portions 118, the temple sections 120, 130, and/or the hinges 122, 132. The bridge portion 112, however, may have a different size, shape, configuration, and/or arrangement. For instance, while the bridge portion 112 may be disposed in a generally horizontal, flat, or level configuration, the bridge portion 112 may also extend upwardly. For example, while the bridge portion 112 may extend forwardly and span a portion of the wearer's nose, such as shown in FIGS. 1-24, the bridge portion 112 could also extend upwardly. In an exemplary embodiment, the bridge portion 112 may be at least partially disposed between the wearer's eyes. For example, the bridge portion 110 may be generally aligned with an upper portion, a middle portion, and/or a lower portion of the wearer's eyes. Further, the bridge portion 112 may be generally disposed in the same vertical plane as the cheek portions 116. Thus, instead of the bridge portion 112 extending forwardly to traverse the nose of the wearer, such as one or more of the embodiments described above, the bridge portion 112 may extend upwardly and may generally go around all or an upper portion of the nose of the wearer. As shown in the figures, the upper most portion of the bridge portion 112 may be rounded and the bridge portion may have a generally inverted U-shaped configuration.

Yet another exemplary embodiment of the frame 100 is shown in FIGS. 41-48. In this exemplary embodiment, the frame 100 may include the central section 110, the bridge portion 112, the nose pads 114, the cheek portions 116, the connecting portions 118, the temple sections 120, 130, and/or the hinges 122, 132. The bridge portion 112, however, may have a different size, shape, configuration, and/or arrangement. In this exemplary embodiment, the bridge portion 112 may be generally horizontally disposed and the bridge portion 112 may not extend outwardly. For example, the bridge portion 112 may be disposed in generally the same vertical plane as a portion of the cheek portions 116 and/or a portion of the connecting portions 118. The bridge portion 112 may be disposed proximate a central or an upper portion of the wearer's nose. The bridge portion 112 may be generally aligned with a lower portion of the wearer's eyes. For example, the bridge portion 112 may span a portion of the wearer's nose, be generally aligned with a lower portion of the wearer's eyes, and may not extend outwardly and/or upwardly. Further, a front surface of the bridge portion 112 may be generally aligned with a front surface of the cheek portions 116 and/or the connection portions 118. Thus, instead of the bridge portion 112 extending forwardly to traverse the nose of the wearer, the bridge portion 112 may have a generally straight or aligned configuration. In addition, the bridge portion 112 may be disposed between a lower portion of the wearer's eyes and a midpoint of the wearer's nose. Thus, in this configuration, the bridge portion 112 may not extend outwardly relative to the wearer's face and/or the bridge portion 112 may not be disposed between the eyes of the wearer.

In some embodiments, the frame 100 may be substantially symmetrical. For example, the frame 100 may be substantially symmetrical relative to a vertical axis. One or more portions of the frame 100 may also be mirror images. For example, the first and/or second hinges 122, 132, and the left and/or right temple sections 120, 130 may be mirror images. After reviewing this disclosure, one skill in the art will apricate that the frame 100 does not have to be symmetrical and/or include mirror images because the frame 100 may have other shapes, sizes, configurations, and/or arrangements depending, for example, upon the intended use of the frame 100.

As discussed above, the frame 100 may include one or more features, which may be referred to as attachment mechanisms or attachment portions 140, that facilitate connection of the frame 100 and a mask. For example, as shown in FIGS. 25-32, the frame 100 may include one or more attachment portions 140 along the left temple section 120 and/or the right temple section 130. In an exemplary embodiment, the attachment portions 140 may include a first opening 142 and a second opening 144 along the left temple section 120, and a first opening 146 and a second opening 148 along the right temple section 130. The openings 142, 144, 146, and 148 may be sized and configured to allow a face mask to be attached to the frame 100. For example, the face mask may include a line, cord, or the like that may be attached to one or more of the 142, 144, 146, and/or 148. After reviewing this disclosure, one of ordinary skill in the art will appreciate that the frame 100 may include any suitable number of attachment portions 140, such as the openings 142, 144, 146, and 148, and the attachment portions 140 may have other shapes, sizes, configurations, and/or arrangements depending, for example, upon the intended use of the frame 100.

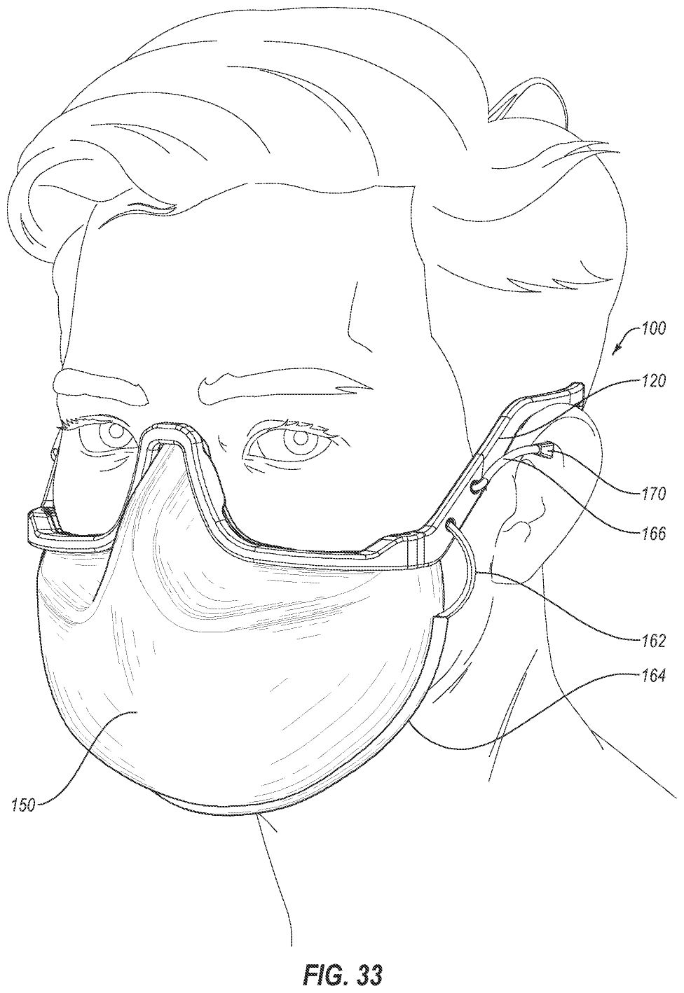

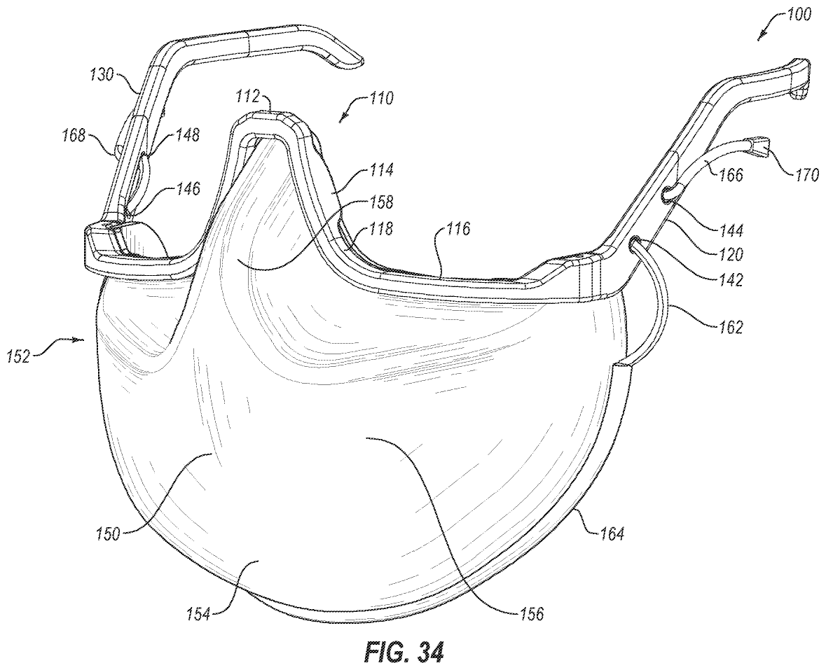

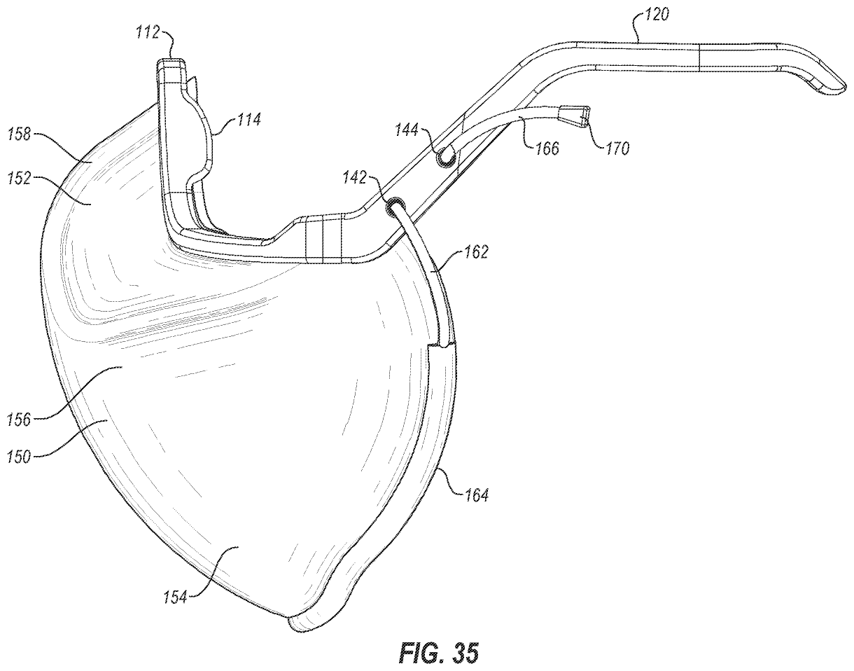

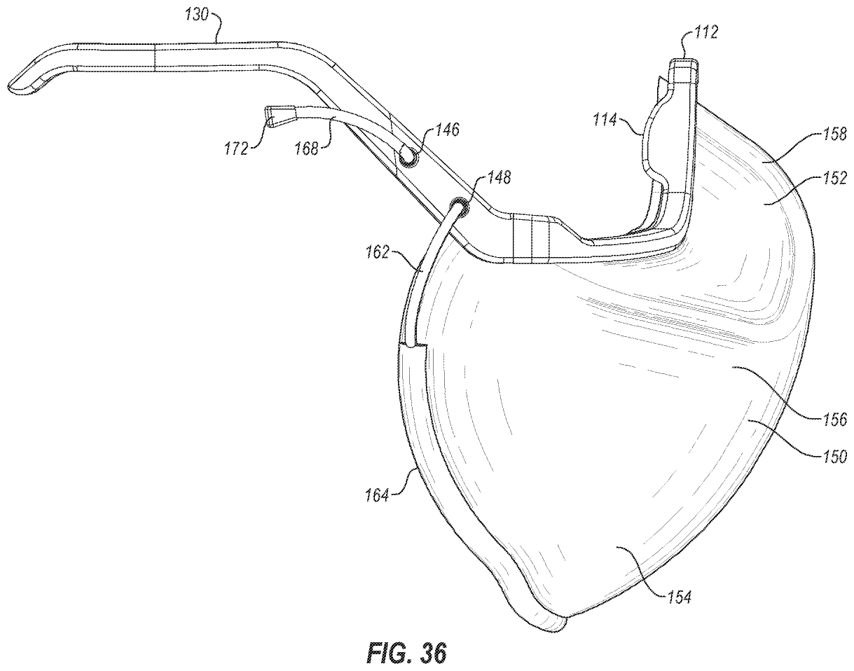

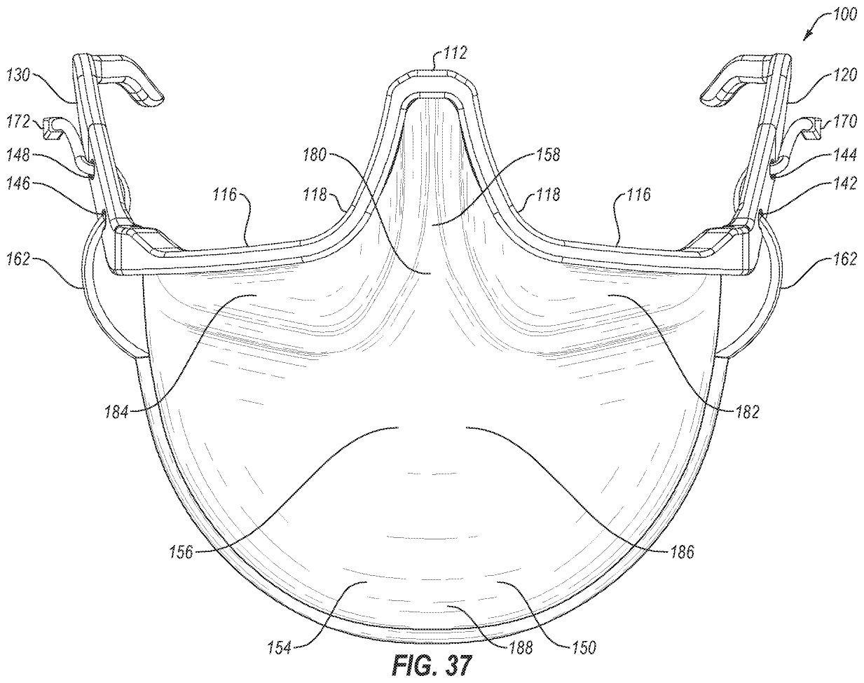

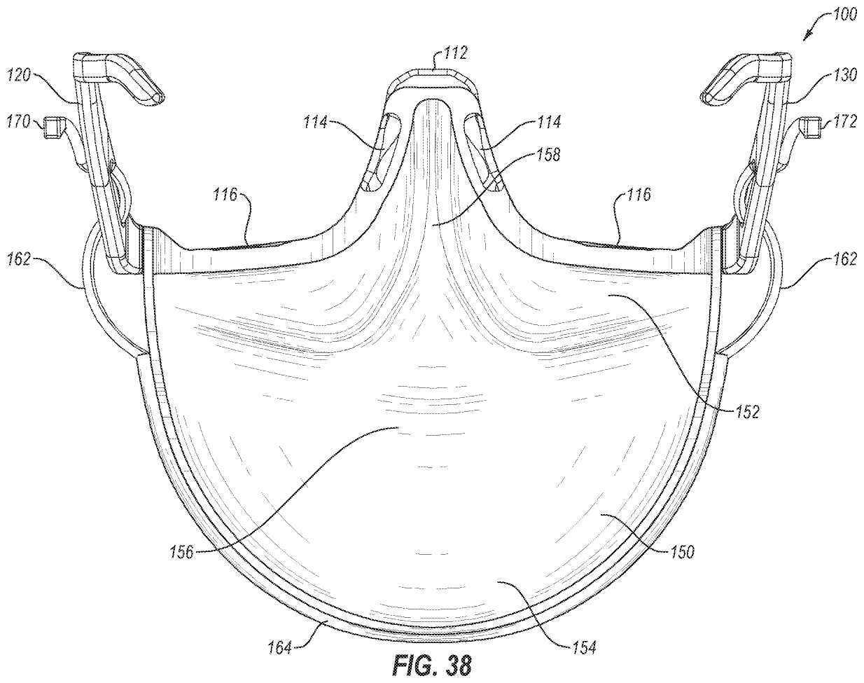

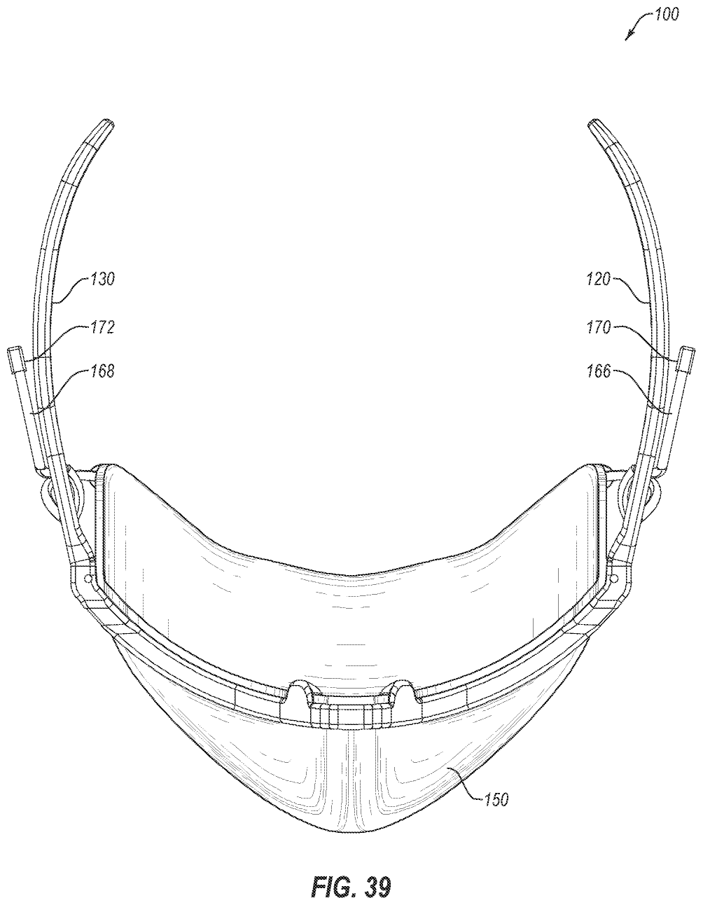

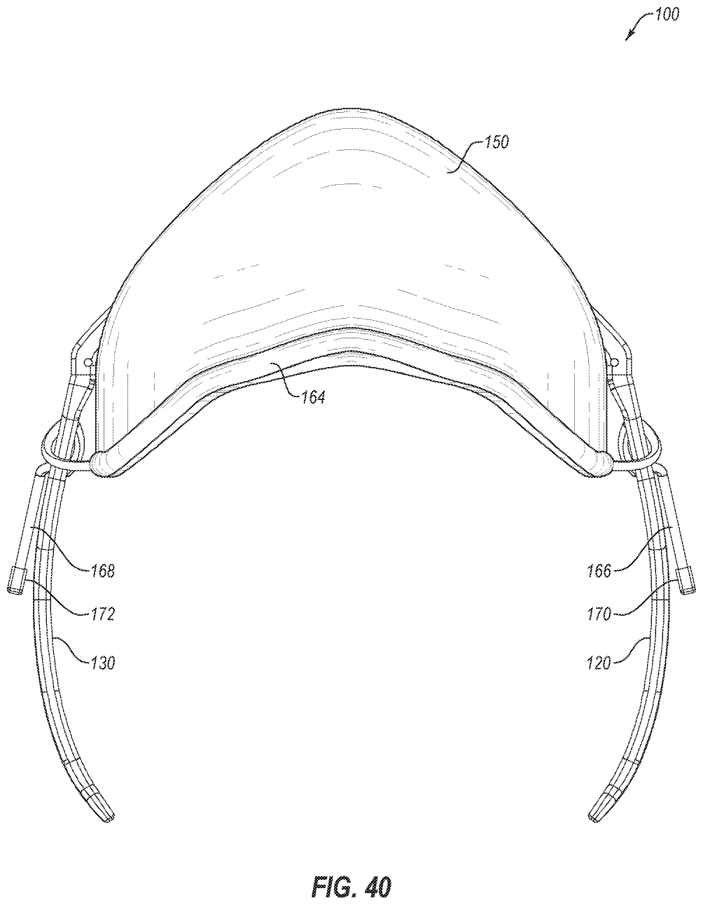

As shown in FIGS. 33-40, an exemplary face mask 150 may be attached to the frame 100. For example, the frame 100 may include the central section 110, the bridge portion 112, the nose pads 114, the cheek portions 116, the connecting portions 118, the temple sections 120, 130, the hinges 122, 132, and/or the attachment portions 140 such as the openings 142, 144, 146, and 148. The face mask 150 may include an upper portion 152, which may be sized and configured to be attached to the frame 100, and a lower portion 154. The face mask 150 may also include a central portion 156 and a nose portion 158. The central portion 156 may generally cover the mouth of the wearer and the nose portion 158 may generally cover the nose of the wearer.

In the exemplary embodiment shown in FIGS. 33-40, the frame 100 may include a central section 110 with a bridge portion 112 that may be configured to cross the wearer's nose approximately between the wearer's eye-level. This may allow the nose portion 158 of the face mask 150 to cover at least substantially all of the wearer's nose. In addition, because the face mask 150 may extend outwardly relative to the frame 100 and/or the face of the wearer, the face mask 150 may be comfortable to wear.

As shown in the accompanying figures, the upper portion 152 of the face mask 150 may be attached to the central section 110 of the frame 100. For example, the face mask 150 may be attached to the bridge portion 112 and/or the cheek portions 116 of the frame 100. The face mask 150 may be adjustable. For instance, the face mask 150 may include an adjustment mechanism 160 and the adjustment mechanism 160 may include one or more adjustable portions. The adjustment mechanism 160 may include a line 162, such as a cord, string, cable, wire, and the like, and the line 162 may be attached to a portion of the face mask 150. For example, the line 162 may be disposed in a sleeve 164 and the sleeve 164 may be disposed about a portion of the face mask 150. As shown in the accompanying figures, the sleeve 164 may be disposed about the lower portion 154 of the face mask 150 and the line 162 may extend through the sleeve 164. The sleeve 164 may be sized and configured to position the face mask 150 relative to the face of the wearer. The line 162 may include a first end 166 and the first end may be disposed at least proximate a first side of the frame, such as the left temple section 120. The line 162 may include a second end 168 and the second end may be disposed at least proximate a second side of the frame, such as the right temple section 130. The first end 166 of the line 162 may include a cap or covering 170 and the second end 168 of the line 162 may include a cap or covering 172.

The line 162 may be attached to the one or more attachment portions 140, such as the openings 142, 144, 146, and/or 148. For example, the first end 166 of the line 162 may be disposed in the openings 142, 144 on the left temple section 120, and the second end 168 of the line 162 may be disposed in the openings 146, 148 on the right temple section 130. This may allow the wearer, for example, to tighten and/or loosen the lower portion 154 of the face mask 150 around the wearer's face. Advantageously, the adjustable face mask 150 may increase the comfort and wearability of the face mask. After reviewing this disclosure, one of ordinary skill in the art will appreciate that the face mask 150 may be attached to the frame 100 using a variety of suitable methods and the attachment portions 140 may have other shapes, sizes, configurations, and/or arrangements depending, for example, upon the intended use of the face mask 150.

In some embodiments, the line 162 may serpentine through the openings 142, 144, 146, and/or 148. For example, the first end 166 of the line 162 may pass through the openings 142 and/or 144 on one side of the frame 100, and the second end 168 of the line 162 may pass through the openings 146 and/or 148 on the second side of the frame 100. The serpentine configuration of the line 162 through the openings 142, 144, 146, and/or 148 may substantially hold the line 162 in the place. The caps or coverings 170, 172 may also be used to help hold the line 162 in place and/or facilitate adjustment of the line 162. For example, the wearer may pull on the caps or coverings 170 and/or 172 to tighten the face mask 150 around the face of the wearer.

If the line 162 and sleeve 164 are disposed about the lower portion 154 of the face mask 150, that may facilitate tightening the face mask 150 about the chin of the user. It will be appreciated that the line 162 may traverse other portions of the face mask 150, including interior and/or exterior portion of the face mask 150. Alternatively, and/or additionally, more than one line 162 may be used, and/or the line 162 may include one or more components or pieces, which may be distributed through one or more portions of the face mask 150. This may allow, for example, one or more portions of the face mask 150 to be tightened and/or loosened. For example, the line 162 may be distributed throughout one or more portions of the face mask 150, which may allow one or more portions of the face mask 150 to be tightened to the wearer's face.

In some embodiments, the face mask 150 may include a shape sized and configured to cover portions of the wearer's face. For example, as seen in FIGS. 33-40, the face mask 150 may include a protruded nose section 180 that may accommodate the wearer's nose; first and second depressions 182, 184 that may be disposed proximate the nose section 180 and/or below the eyes and the depressions may provide a more open and/or unobstructed view; a rounded front section 186 to cover the wearer's mouth and some or all of the wearer's cheeks; and a bottom curved section 188 to cover some or all of the wearer's chin. Alternatively, and/or additionally, the face mask 150 may have other suitable shapes, sizes, configurations, and/or arrangements including, for example, a shape that may similar to conventional surgical mask.

In some embodiments, the face mask 150 may be constructed from materials such as fabric. The fabric may be a filtering fabric material, such as electrostatic non-woven polypropylene fiber, spunbound polypropylene, foam backed fabrics, laminated fabrics, cellulose, cotton, linen, flannel, denim, silk, and other similar fabrics. Alternatively, and/or additionally, the face mask 150 may be constructed from other materials and/or combinations of materials. For example, the face mask 150 may include an outer surface at least partially constructed from a material such as electrostatic non-woven polypropylene fiber and an inner surface at least partially constructed from a material such as cellulose. Alternatively, and/or additionally, the face mask 150 may include one or more layers of materials, including one or more layers of fabric materials. For example, the face mask 150 may include laminated fabric as an outer surface, foam backed fabric as a middle material, and silk as an inner surface. Various combinations of fabric materials may contribute to the effectiveness of the face mask 150 to filter particulates and may also contribute to the face mask 150 maintaining a structure or configuration that provides space around the wearer's nose and/or mouth to enable easier breathing.

In some embodiments, the face mask 150 may include a substantially convex shape which may contribute to increased comfort and/or easier breathing for the wearer while using the frame 100 and/or the face mask 150. In some embodiments, the face mask 150 may remain in a substantially convex shape even when in use. In some embodiments, the face mask 150 may include one or more structures, materials, fabrics, etc. which may be at least partially rigid and/or semi-rigid, which may contribute to the face mask 150 retaining a substantially convex shape when being worn and/or used. For example, the face mask 150 may include a foam backed fabric that may be substantially convex in shape. Alternatively, and/or additionally, the face mask 150 may include one or more supports and the supports may help provide a convex shape to the face mask 150.

The frame 100 and the face mask 150 may be selectively and/or permanently connected by one or more connecting members 190. The connecting members 190 may be used independently and/or in combination with the attachment portions 140. In an exemplary embodiment, the connecting members 190 may be one or more fasteners, adhesives, and the like that may be used to connect the frame 100 and the face mask 150. For example, the central section 110 of the frame 100 may include an adhesive, such as a strip of reusable adhesive, that may be used to attach the face mask 150 to the frame 100. The adhesive may allow the face mask 150 to be selectively and/or permanently connected to the frame 100.

Alternatively, and/or additionally, the frame 100 and the face mask 150 may be connected by connecting members 190 such as magnets. For example, a portion of the frame 100, such as the central section 110, may include one or more magnets. The magnets may be relatively small, embedded in the frame 100, and/or dispersed through the central section 110 of the frame 100. The face mask 150 may include magnets and/or magnetic materials that may be attracted to the magnets in the frame 100. For example, one or more magnets or magnetic materials may be attached to a portion of the face mask 150, such as the upper portion 152. The face mask 150 and the frame 100 may be attached when the magnetic portions and/or magnetic materials are brought into close proximity. This may allow the face mask 150 to be selectively attached and/or detached from the frame 100.

The frame 100 and the face mask 150 may be connected by other types of connecting members 190 such as strips of fabric. For example, one or more strips of fabric may be attached to the upper portion 152 of the face mask 150 and the strips of fabric may be disposed about a portion of the frame 100. For instance, the strips of fabric may be looped over a portion of the frame 100, such as the central section 110, to attach the face mask 150 to the frame 100.

FIGS. 41-48 illustrate another exemplary embodiment of the frame 100. The frame 100 may include the central section 110, the bridge portion 112, the nose pads 114, the cheek portions 116, the connecting portions 118, the temple sections 120, 130, and/or the hinges 122, 132. The frame 100 may include one or more connecting members 190 such as a first opening 192 and a second opening 194. The first and second openings 192, 194 may be disposed proximate the ends of the central section 110 of the frame 100. In this exemplary embodiment, the first opening 192 may have an elongated configuration and may be disposed on a first side of the central section 110, and the second opening 194 may have an elongated configuration and may be disposed on a second side of the central section 110 of the frame 100.

As shown in FIGS. 41-48, the bridge portion 112 may have a generally horizontal configuration, and the bridge portion 112 may be generally horizontally aligned with a portion of the nose pads 114. For example, the bridge portion 112 may be generally horizontally aligned with a central portion of the nose pads 114. In an exemplary embodiment, a centerline of the bridge portion 112 may be generally aligned with a centerline of the nose pads 114. The upper portion of the nose pads 114 may extend above an upper surface of the bridge portion 112. Because the bridge portion 112 may be generally aligned with a portion of the nose pads 114, the bridge portion 112 may be generally out of sight of the user.

In some embodiments, the nose pads 114 may be coupled to the bridge portion 112 and/or the connecting portions 118 of the frame 100. The nose pads 114 may be coupled to the bridge portion 112 and/or the connecting portions 118 by hinges. For example, the first nose pad 114a may be coupled to the left side of the bridge portion 112 and/or the first connecting portion 118a by a first hinge. The second nose pad 114b may be coupled to the right side of the bridge portion 112 and/or the second connecting portion 118b by a second hinge. In some embodiments, the nose pads 114 may include a spring. Alternatively, and/or additionally, the hinged nose pads 114 may be configured to move between a first position and a second position.

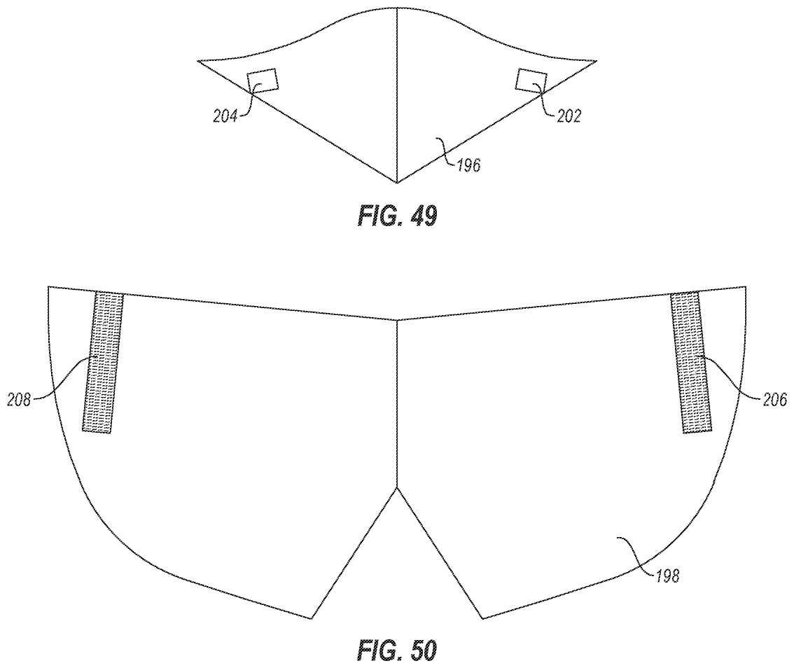

FIGS. 49 and 50 illustrate the face mask 150 may include one or more portions. For example, the face mask 150 may include a first portion 196 and a second portion 198, and the first and second portions 196, 198 may be connected to form at least a portion of the face mask 150. The first portion 196 and the second portion 198 may include one or more connecting portions 200 and the connecting portions 200 may facilitate connection of the face mask 150 and the frame 100. For example, the first portion 196 of the face mask 150 may include a first connecting portion 202 and a second connecting portion 204, and the second portion 198 of the face mask 150 may include a first connecting portion 206 and a second connecting portion 208. The first connecting portion 202 and the second connecting portion 204 in the first portion 196 of the face mask 150 may be openings, and the first connecting portion 206 and the second connecting portion 208 in the second portion 198 of the face mask 150 may include hook and loop fasteners. The connecting portions 202, 204, which may include openings, and the connecting portions 206, 208, which may include hook and loop fasteners, may facilitate connection of the face mask 150 to the frame.

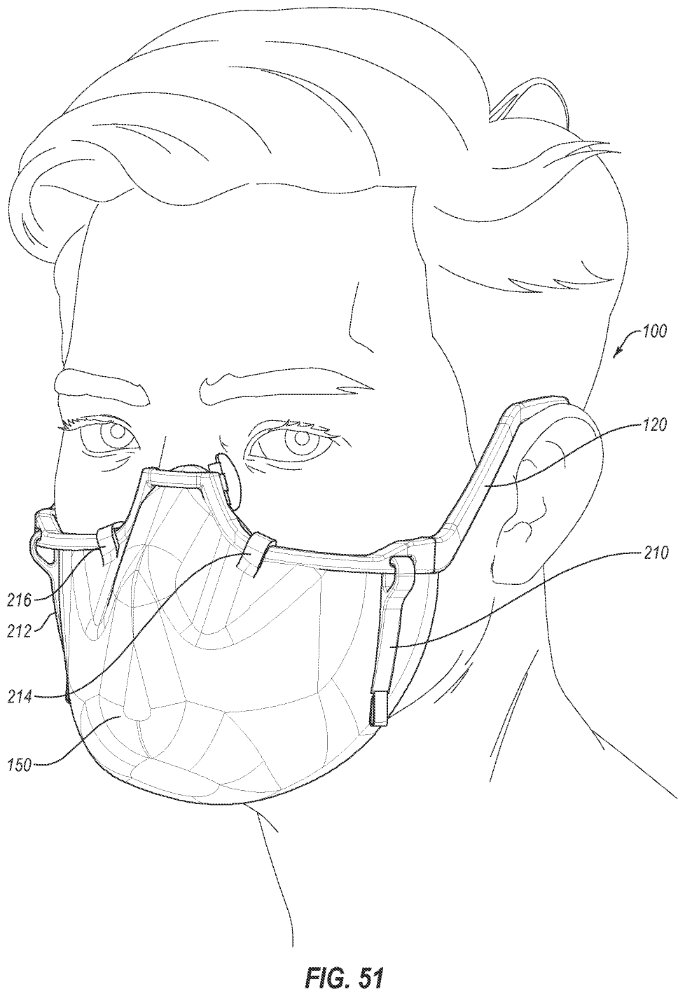

FIGS. 51-58 illustrate another exemplary configuration of the frame 100 and the face mask 150. The frame 100 may include the central section 110, the bridge portion 112, the nose pads 114, the cheek portions 116, the connecting portions 118, the temple sections 120, 130, and/or the hinges 122, 132. The frame 100 may include one or more connecting members 190, such as the first opening 192 and the second opening 194. In some embodiments, the first opening 192 may be disposed proximate the first hinge 122 and the second opening 194 may be disposed proximate the second hinge 132.

As shown in FIGS. 51-58, the face mask 150 may be attached to the frame 100. For example, if the frame 100 includes the first opening 192 and/or the second opening 194, the openings may facilitate attachment of the face mask 150 and the frame 100. The openings 192, 194, which may be disposed in lateral portions of the frame 100, such as near the hinges 122, 132, may be sized and configured to facilitate connection of the face mask 150 and the frame 100. For example, a first connector 210 may extend through the first opening 192 in the face mask 150 and a second connector 212 may extend through the second opening 194 in the face mask 150. The first connector 210 may include hook and loop fasteners that may be connected to the first connecting portion 206 on the face mask 150. The second connector 212 may include hook and loop fasteners that may be connected to the second connecting portion 208 of the face mask 150. The openings 192, 194 may help position the face mask 150 in the desired position, and the connecting portions 206, 208 and the connectors 210, 212 may allow the face mask 150 and the frame 100 to be selectively connected.

The connecting portions 202, 204 may facilitate attachment of the face mask 150 and the frame 100. For example, a third connector 214 may be at least partially disposed about the frame 100 and within the first connecting portion 202 in the face mask 150, and a fourth connector 216 may be at least partially disposed about the frame 100 and within the second connecting portion 204 in the face mask 150. The third connector 214 may include a loop portion and a fastener, and the fourth connector 216 may include a loop portion and a fastener. The loop portion and the fastener of the third and fourth connectors 214, 216 may allow the face mask 150 and frame 100 to be connected.

After reviewing this disclosure, one of ordinary skill in the art will appreciate that the connecting members (such as the connecting members 190), connecting portions (such as the connecting portions 200, 202, 204, 206, and/or 208), connectors (such as the connectors 210, 212, 214, and/or 216), fasteners, and the like may have other suitable shapes, sizes, configurations, and/or arrangements. Additionally, after reviewing this disclosure, one skilled in the art will appreciate the frame 100 and/or the face mask 150 may have various shapes, sizes, configurations, and/or arrangements.

The accompanying drawings illustrate various exemplary embodiments of the frame 100 and the face mask 150. After reviewing this disclosure, one of ordinary skill in the art will appreciate that the frame 100 and/or the face mask 150 may include other parts, components, and the like, and that not all of the disclosed parts, components, and the like may be required.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

1. An eyeglasses-like frame, comprising:
a central section sized and configured to horizontally traverse at least a portion of a wearer's face, the central section comprising:
a first cheek portion sized and configured to be disposed at least proximate a cheek of the wearer;
a second cheek portion sized and configured to be disposed at least proximate a cheek of the wearer, the first cheek portion and the second cheek portion generally horizontally aligned;
a first nose pad disposed proximate the first cheek portion;
a second nose pad disposed proximate the second cheek portion, the first nose pad and the second nose pad spaced apart by a distance; and
a bridge portion disposed between the first cheek portion and the second cheek portion, the bridge portion generally horizontally aligned, the bridge portion horizontally disposed above the first cheek portion and the second cheek portion, the bridge portion configured to be disposed below a lower portion of the wearer's eyes;
a first temple section hingedly connected to a first lowermost portion of a first side of the central section; and
a second temple section hingedly connected to a second lowermost portion of a second side of the central section.

2. (canceled)

3. (canceled)

4. The eyeglasses-like frame of claim 1, wherein the bridge portion is disposed between a generally horizontal plane aligned with the first cheek portion and the second cheek portion, and a generally horizontal plane aligned with a midpoint of the first nose pad and the second nose pad.

5. The eyeglasses-like frame of claim 1, wherein the first temple section is configured to extend from the first lowermost portion of the central section to a position above the wearer's left ear; and
wherein the second temple section is configured to extend from the second lowermost portion of the central section to a position above the wearer's right ear.

6-8. (canceled)

9. The eyeglasses-like frame of claim 1, further comprising hook and loop fasteners attached to the central section of the eyeglasses-like frame, the hook and loop fasteners sized and configured to facilitate attachment of a mask to the eyeglasses-like frame.

10. The eyeglasses-like frame of claim 1, further comprising:
a first padded insert attached to the first nose pad;
a second padded insert attached to the second nose pad;
a first sleeve attached to the first temple section; and
a second sleeve attached to the second temple section,
wherein the first padded insert, the second padded insert, the first sleeve, and the second sleeve are comprised of silicone.

11. The eyeglasses-like frame of claim 1, further comprising a mask attached to the eyeglasses-like frame, the mask connected to the first cheek portion, the second cheek portion, and the bridge portion.

12. The eyeglasses-like frame of claim 1, further comprising a mask attached to the eyeglasses-like frame, a first portion of the mask inserted through a first opening in the eyeglasses-like frame to attach the mask to the eyeglasses-like frame, a second portion of the mask inserted through a second opening in the eyeglasses-like frame to attach the mask to the eyeglasses-like frame.

13. (canceled)

14. The eyeglasses-like frame of claim 1, further comprising a mask attached to the eyeglasses-like frame, a first lateral outer portion of the mask including a hook and loop fastener sized and configured to facilitate attachment of the mask to the eyeglasses-like frame, a second lateral outer portion of the mask including a hook and loop fastener sized and configured to facilitate attachment of the mask to the eyeglasses-like frame.

15. (canceled)

16. (canceled)

17. An eyeglasses-like frame, comprising:
a central section sized and configured to horizontally traverse at least a portion of a wearer's face, the central section comprising:
a first cheek portion sized and configured to be disposed at least proximate a cheek of the wearer;
a second cheek portion sized and configured to be disposed at least proximate a cheek of the wearer;
a bridge portion disposed between the first cheek portion and the second cheek portion;
a first nose pad disposed between the first cheek portion and the bridge portion; and
a second nose pad disposed between the second cheek portion and the bridge portion;
a first temple section hingedly connected to a first lowermost portion of a first side of the central section; and
a second temple section hingedly connected to a second lowermost portion of a second side of the central section.

18. The eyeglasses-like frame of claim 17, wherein the bridge portion extends upwardly and has a generally inverted U-shaped configuration; and
wherein a first surface of the bridge portion is generally vertically aligned with a first surface of the first cheek portion and a first surface of the second cheek portion.

19. (canceled)

20. The eyeglasses-like frame of claim 17, further comprising:
a mask;
a first opening in the central section of the eyeglasses-like frame;
a first connector connecting the mask to the first opening in the central section of the eyeglasses-like frame;
a second opening in the central section of the eyeglasses-like frame;
a second connector connecting the mask to the second opening in the central section of the eyeglasses-like frame;
a first opening in the mask;
a third connector connecting the first opening in the mask to the central section of the eyeglasses-like frame;
a second opening in the mask; and
a fourth connector connecting the second opening in the mask to the central section of the eyeglasses-like frame.

21. An eyeglasses-like frame, comprising:
a central section sized and configured to horizontally traverse at least a portion of a wearer's face, the central section comprising:
a first cheek portion sized and configured to be disposed at least proximate a cheek of the wearer;
a second cheek portion sized and configured to be disposed at least proximate a cheek of the wearer, the first cheek portion and the second cheek portion generally horizontally aligned;
a first nose pad disposed proximate the first cheek portion;
a second nose pad disposed proximate the second cheek portion, the first nose pad and the second nose pad spaced apart by a distance; and
a bridge portion disposed between the first cheek portion and the second cheek portion, the bridge portion horizontally disposed above the first cheek portion and the second cheek portion;
a first temple section connected to a first side of the central section, the connection of the first temple section and the first side of the central section disposed below a plane generally aligned with the bridge portion;
a second temple section connected to a second side of the central section, the connection of the second temple section and the second side of the central section disposed below the plane generally aligned with the bridge portion; and
a mask connected to the central section of the eyeglasses-like frame, the disposed on an inner surface of the eyeglasses-like frame, the mask configured to be disposed between the eyeglasses-like frame and the wearer.

22. The eyeglasses-like frame of claim 21, wherein the bridge portion is disposed below an upper portion of the first nose pad and an upper portion of the second nose pad.

23. The eyeglasses-like frame of claim 21, wherein the bridge portion is configured to be disposed below eye level;
wherein the first temple section is connected to a lowermost portion of the first side of the central section;
wherein the second temple section is connected to a lowermost portion of the second side of the central section;
wherein a mask is sized and configured to be connected to the eyeglasses-like frame; and
wherein one or more connectors are sized and configured to connect the mask to the central section of the eyeglasses-like frame.

24. The eyeglasses-like frame of claim 21, wherein the mask is configured to contact the wearer's face and create a seal therebetween.

25. The eyeglasses-like frame of claim 1, further comprising:
one or more first apertures disposed in the first temple section; and
one or more second apertures disposed in the second temple section,
wherein the one or more first apertures and the one or more second apertures are configured to facilitate attachment of a mask to the eyeglasses-like frame.

26. The eyeglasses-like frame of claim 17, further comprising:
one or more first apertures disposed in the first temple section; and
one or more second apertures disposed in the second temple section,
wherein the one or more first apertures and the one or more second apertures are configured to facilitate attachment of a mask to the eyeglasses-like frame.

27. The eyeglasses-like frame of claim 21, further comprising:
one or more first apertures disposed in the first temple section; and
one or more second apertures disposed in the second temple section,
wherein the one or more first apertures and the one or more second apertures are configured to facilitate attachment of a mask to the eyeglasses-like frame.

28. The eyeglasses-like frame of claim 1, wherein the central section of the eyeglasses-like frame is sized and configured to be connected to a mask, at least a portion of the mask disposed between an inner surface of the eyeglasses-like frame and the wearer so that a portion of the mask is sandwiched between the inner surface of the eyeglasses-like frame and the wearer.

29. The eyeglasses-like frame of claim 17, wherein the central section of the eyeglasses-like frame is sized and configured to be connected to a mask, at least a portion of the mask disposed between an inner surface of the eyeglasses-like frame and the wearer to allow a seal to be created between the mask and the wearer.
